(19) United States
(12) Patent Application Publication
(10) Pub. No.: US 2024/0221751 A1
(43) Pub. Date: Jul. 4, 2024

(54) WEARABLE SILENT SPEECH DEVICE, SYSTEMS, AND METHODS

(71) Applicant: Wispr Al, Inc., South San Francisco, CA (US)

(72) Inventors: Sahaj Garg, Foster City, CA (US); Tanay Kothari, San Francisco, CA (US); Anthony Leonardo, Broadlands, VA (US); Lucas Marsh, San Francisco, CA (US); Dawid Bodgal, Gilroy, CA (US); Jeff Talbot, Reston, VA (US)

(73) Assignee: Wispr Al, Inc., South San Francisco, CA (US)

(21) Appl. No.: 18/338,827

(22) Filed: Jun. 21, 2023

Related U.S. Application Data
(60) Provisional application No. 63/437,088, filed on Jan. 4, 2023.

(51) Int. Cl. G10L 15/24; G06F 3/01; G10L 15/22

(52) U.S. Cl. CPC G10L 15/24; G06F 3/011; G10L 15/22; G10L 2015/223

(57) ABSTRACT

Techniques, including a system, device and method, for decoding and using silent speech signals are provided. The techniques may record silent speech signals using a wearable device, worn by a user. The techniques may analyze the silent speech signals to determine one or more outputs including words or phrases from the silent speech signals. The techniques may comprise using machine learning models to determine the one or more outputs. The techniques may involve performing one or more actions in response to the one or more outputs. The one or more actions may include natural language processing, executing a command on a device and providing information, among other actions. The techniques may involve generating an audio signal for communication from silent speech signals.

### CROSS-REFERENCE TO RELATED APPLICATIONS

This application claims the benefit under 35 U.S.C. § 119(e) of U.S. Provisional Application No. 63/437,088, entitled “SYSTEM AND METHOD FOR SILENT SPEECH DECODING,” filed Jan. 4, 2023, the entire contents of which are incorporated herein by reference.

### BACKGROUND

Traditional communication modalities and interactive systems require user inputs including voiced speech, typing and/or selection of various system inputs during use. Many of these interactive systems use various input methods and devices, such as microphones, keyboard/mouse devices and other devices and methods for receiving inputs from users.

### SUMMARY

The inventors have recognized and appreciated that conventional interactive systems are unable meet the real-world needs of users. For example, it is not always practical for a user to enter text with a keyboard. Also, some existing systems accept user's voice as input to the systems. However, voice-based systems may not always be practical when the environment has noise (e.g., in a public place, in an office etc.) or privacy is of concern.

According to one aspect a wearable device is provided. The device comprises a plurality of electrodes, wherein a subset of the plurality of electrodes are configured to measure electrical signals at face, head, and/or neck of a user, the electrical signals being indicative of the user's speech activation patterns while the user is speaking out loud, whispering, or silently speaking, a processing component configured to receive the electrical signals from the plurality of electrodes and perform one or more processing operations of the electrical signals, and a communication component communicatively coupled to an external device.

According to one embodiment, the plurality of electrodes is configured to record electrical signals from one or more of the user's facial muscles including the zygomaticus, masseter, buccinator, risorius, platysma, depressor labii inferioris and/or depressor anguli oris.

According to one embodiment, the subset of electrodes is selected by a control component to record the electrical signals.

According to one embodiment, the plurality of electrodes is supported to contact the user's face by a sensor arm. According to one embodiment, the sensor arm is coupled to an ear hook, the ear hook configured to support the wearable device at an ear of the user. According to one embodiment, the sensor arm is coupled to a headset, the headset configured to support the sensor arm at a side of a head of the user. According to one embodiment, the sensor arm is coupled to a helmet, the helmet configured support the sensor arm at a side of a head of the user. According to one embodiment, the plurality of electrodes is supported to contact the user's face by a strap. According to one embodiment, the strap is configured to fit to a head of the patient. According to one embodiment, the strap is coupled to a helmet. According to one embodiment, the plurality of electrodes is supported to contact the user's face by a mask portion of a full face helmet. According to one embodiment, the sensor arm is supported at a side of the user's head.

According to one embodiment, the plurality of electrodes is a first plurality of electrodes and the wearable device further comprises a second plurality of electrodes. According to one embodiment, the first plurality of electrodes is supported to contact a user's face by a first sensor arm and the second plurality of electrodes is supported to contact a user's face by a second sensor arm. According to one embodiment, the first and second pluralities of electrodes are supported to contact the users face at respective first and second locations on the user's face. According to one embodiment, the first location on the user's face is at a first check of the user. According to one embodiment, the second location on the user's face is at a second check of the user. According to one embodiment, the second location on the user's face is at the chin of the user. According to one embodiment, the second location on the user's face is under a jaw of the user. According to one embodiment, the sensor arm is coupled to a temple of glasses.

According to one embodiment, the sensor arm is configured to be rotatably positioned about an anchor point. According to one embodiment, the sensor arm is configured to be linearly positioned closer and farther from the user's mouth. According to one embodiment, the sensor arm is configured to be positioned closer and farther from a user's check. According to one embodiment, the device comprises a spring configured to maintain contact between the sensor arm and the user's check. According to some embodiments, the spring is a torsion spring, leaf spring, rubber spring, coil spring, conical spring, or rubber gasket. According to one embodiment, the device comprises a compliant mechanism that has spring like properties that enables the sensor arm to maintain contact with the user's cheek. According to one embodiment, the spring is a leaf spring. According to one embodiment, the spring is a rubber spring.

According to one embodiment, the plurality of electrodes (or electrode array) is on a rigid component. According to one embodiment, the electrode array is flat. According to one embodiment, the electrode array is curved. According to one embodiment, the electrode array is not rigid and can conform to the surface of the user's skin as they move and speak. According to one embodiment, there is a joint connecting the electrode array to the sensor arm. According to one embodiment, the joint connecting the electrode array and sensor arm can be tuned with two or three degrees of freedom. According to one embodiment, the joint can be fixed rigidly in place after being tuned. According to one embodiment, one or more of those degrees of freedom can be locked. According to some embodiments, the joint is implemented via a rubber spring, ball and socket joint, flexure, U-joint, or hinge. According to one embodiment, the sensor arm or plurality of sensor arms can be rotated into a ‘stowed away’ position when the device is not being used.

According to one embodiment, the plurality of electrodes comprises domed electrodes. According to one embodiment, the plurality of electrodes comprises gold plated brass electrodes, silicon electrodes or silver electrodes or Ag/AgCl electrodes. According to one embodiment, the plurality of electrodes comprises one or more reference electrodes configured to bias the body of the user such that the body is within the optimal linear range of the system sensors. According to one embodiment, the one or more reference electrodes are configured to statically bias the body. According to one embodiment, the one or more reference electrodes are configured to dynamically bias the body as a function of a common mode voltage as a function of measurements of non-inverting and inverting inputs. According to one embodiment the one or more reference electrodes are configured to dynamically bias the body in a manner similar to a driven right leg (DRL) circuit.

According to one embodiment, the reference electrode is supported to contact the body of the user behind an ear of the user. According to one embodiment, the reference electrode is supported to contact the body of the user at a location of a mastoid of the user.

According to one embodiment, the plurality of electrodes is configured as a differential amplifier, wherein the electrical signals represent a difference between a voltage measured at an inverting electrode and a voltage measured at a non-inverting electrode at the face, head and/or neck of the user.

According to one embodiment, the inverting electrode is placed within proximity of the non-inverting electrodes. According to another embodiment, the inverting electrode is placed on the mastoid of the user or behind the ear. According to another embodiment, there are two inverting inputs. In one embodiment, these two inverted electrodes are connected or shorted together. In another embodiment, a control component selects between the two inverting electrodes, optionally based on the quality of contact between the inverting electrode and the user. According to one embodiment, each non-inverting electrode has a corresponding inverting electrode, and measures the differential between the non-inverting electrode and the corresponding inverting electrode.

According to one embodiment, both the inverting electrode and the one or more reference electrodes are placed behind an ear of the user or on the mastoid of the user.

According to one embodiment, each of the first plurality of electrodes and the second plurality of electrodes comprises a respective first and second reference electrode configured to provide current to a body of the user.

According to one embodiment, the first and second plurality of electrodes are configured as differential amplifiers, wherein the electrical signals represent a difference between a voltage generated by the respective reference electrode of the first and second plurality of electrodes and a voltage generated at the face, head and/or neck of the user.

According to one embodiment, the first plurality of a respective first reference electrode configured to provide current to a body of the user, and the first and second plurality of electrodes are configured as differential amplifiers, wherein the electrical signals represent a difference between a voltage generated by the first reference electrode and a voltage generated by the face, head and/or neck of the user.

According to one embodiment, one or more processing operations include bandpass filtering of analog signals recorded by the plurality of electrodes. According to one embodiment, one or more processing operations include analog to digital conversion of the analog signals recorded by the plurality of electrodes to generate digital signals. According to one embodiment, one or more processing operations include feature extraction of analog signals recorded by the plurality of electrodes to generate feature signals. According to one embodiment, one or more processing operations include feature extraction of the digital signals to generate digital feature signals. According to one embodiment, the processing component is configured to recognize an activation signal recorded by the plurality of electrodes; and is configured to perform processing on signals following the activation signal, in response to recognizing the activation signal. According to one embodiment, one or more processing operations include performing a first layer of a neural network on analog signals recorded by the plurality of electrodes to generate a processed analog vector.

According to one embodiment, one or more processing operations include performing a first layer of a neural network on the digital signals to generate a processed digital vector. According to one embodiment, one or more processing operations include recognizing one or more of the words that were spoken aloud, silently, or whispered by the user. According to one embodiment, these processing operations include the execution of a neural network.

According to one embodiment, the processing component is configured to send a processed signal to the communication component. According to one embodiment, the communication component is configured to package the processed signal for transmission into a packaged signal. According to one embodiment, the communication component is configured to compress the processed signal for transmission into a compressed signal. According to one embodiment, the communication component is configured to transmit the packaged signal to the external device. According to one embodiment, the communication component is configured to transmit the compressed signal to the external device. According to one embodiment, the communication component is configured to transmit the processed signal using one or more of Bluetooth, Wifi, Cellular Network, Ant, Ant+, NFMI and SRW.

According to one embodiment, the device further comprises a control component configured to change a mode of the wearable device, in response to an activation signal recorded by the plurality of electrodes. According to one embodiment, the control component is configured to activate the processing component to perform the one or more processing operations on the electrical signals, in response to the activation signal recorded by the plurality of electrodes. According to one embodiment, the control component is configured to activate the plurality of electrodes to record electrical signals at a frequency of at most 1000 Hz. According to one embodiment, the activation signal is a signal associated with a silent speech activation word.

According to one embodiment, the device further comprises one or more input sensors configured to provide signals to the control component. According to one embodiment, one or more input sensors comprise a button. According to one embodiment, one or more input sensors comprise a capacitive sensor coupled to a surface of the wearable device. According to one embodiment, one or more input sensors are configured to provide a signal to turn on the wearable device and a signal to turn off the wearable device to the control component. According to one embodiment, one or more input sensors are configured to provide a signal to begin recording and a signal to stop recording to the control component. According to one embodiment, one or more input sensors are configured to provide a signal to answer a call to the control component. According to one embodiment, the device further comprises a speaker, and wherein the one or more input sensors are configured to control a volume of the speaker. According to one embodiment, one or more input sensors are configured to control a volume of a speaker of a connected external device. According to one embodiment, one or more input sensors are configured to control a mode of the wearable device. According to one embodiment, one or more input sensors are configured control the pairing of the wearable device with an external device.

According to one embodiment, the wearable device comprises a sensor configured to detect a position of a tongue of the user and transmit to the processing component a signal indicative of the position of the tongue. According to one embodiment, the sensor configured to detect the position of the tongue is one of a laser doppler sensor, a mechanomyography sensor, a sonomyography sensor, an ultrasound sensor, an infrared sensor, a fNIRS sensor, optical sensor, or a capacitive sensor. According to one embodiment, the device further comprises an electroglottography sensor.

According to one embodiment, the device further comprises a microphone, configured to record a voice of the user. According to one embodiment, the microphone is a first microphone and further comprising a second microphone; and wherein the processing component is configured to receive signals from the first and second microphone and perform beamforming on the signals. According to one embodiment, the device further comprises a plurality of microphones, wherein the processing component is configured to receive signals from the plurality of microphones and perform beamforming on the signals received from the plurality of microphones. According to one embodiment, the processing component is configured to perform the beamforming such that audio signals from a location of the user's mouth are amplified.

According to one embodiment, the microphone and plurality of electrodes are configured to record signals simultaneously. According to one embodiment, the device further comprises an input configured to activate one of the microphone or the plurality of electrodes to record signals from the user.

According to one embodiment, the device further comprises a camera. According to one embodiment, the camera is configured to record a face of the user. According to one embodiment, the camera is configured to record an environment of the user.

According to one embodiment, the device further comprises an accelerometer configured to record movement of a jaw of the user. According to one embodiment, the device further comprises an accelerometer configured to record vibrations associated with a user's speech. According to one embodiment, the vibrations are vibrations at a user's neck. According to one embodiment, the vibrations are indicative of glottal activity. According to one embodiment, the vibrations are vibrations of a user's glottis. According to one embodiment, the device further comprises an accelerometer, configured to record movement at a face of the user.

According to one aspect a system is provided. The system comprises the wearable device wherein the communication component is communicatively coupled to an external device, the external device, wherein the external device is configured to receive one or more signals associated with silent speech and recorded by the plurality of electrodes from the communication component, and wherein the external device is configured execute a neural network on the one or more signals from received from the communication component to determine one or more words or phrases silently spoke by the user recorded by the wearable device.

According to one embodiment, the external device is a display device configured to display a user interface. According to one embodiment, the external device comprises a screen and is configured to display the user interface on the screen. According to one embodiment, the external device comprises a projector and is configured to display the user interface via the projector. According to one embodiment, the external device is smart glasses and is configured to display the user interface at one or more lenses of the smart glasses. According to one embodiment, the external device is AR, VR or mixed reality goggles and is configured to display the user interface at one or more lenses of the goggles.

According to one embodiment, the external device comprises one or more processors configured to determine an action to be executed on the user interface from the one or more words or phrases. According to one embodiment, the external device is configured to use natural language processing to determine the action from the one or more words or phrases silently spoke by the user.

According to one embodiment, the external device comprises a camera configured to sense an environment of a user, and the wearable device comprises a speaker. According to one embodiment, the external device is configured to provide environment information to the wearable device in response to receiving a silent speech signal determined, by the external device, to be inquiring about the environment of the user. According to one embodiment, the external device is configured to process a signal from the camera, by performing one or more of object recognition, or place recognition on the signal from the camera. According to one embodiment, the environment information includes one or more of an identity of an object, an identity of a location, a direction, guidance instructions, information about an object, and information about a location. According to one embodiment, the external device is configured to determine a silent speech signal is inquiring about the environment of the user by performing natural language processing to determine if the one or more words or phrases are inquiring about the environment of the user. According to one embodiment, the wearable device is configured to play the environment information on the speaker, in response to receiving the environment information.

According to one embodiment, the external device is configured to provide a virtual assistant platform. According to one embodiment, the external device is configured to provide the one or more words or phrases to the virtual assistant platform; determine a response to the one or more words or phrases using the virtual assistant platform; and transmit the response to the wearable device.

According to one embodiment, the wearable device is configured to play the response on the speaker, in response to receiving the response.

According to one embodiment, the external device is configured to generate an audio signal from the one or more phrases; transmit the audio signal to a second external device; and receive a speech signal from the second device. According to one embodiment, the external device is configured to transmit the speech signal to the wearable device and the wearable device is configured to, in response to receiving the speech signal, play the speech signal on a speaker of the wearable device.

According to one aspect a system is provided. The system comprises the wearable device wherein the communication component is communicatively coupled to an external device and the external device wherein the external device is configured to receive one or more signals from the communication component.

According to one embodiment, the wearable device is configured to transmit first silent speech signals based at least in part on electrical signals recorded by the first plurality of electrodes at a face of the user to the external device and second silent speech signals based at least in part on electrical signals recorded by the second plurality of electrodes at a face of the user to the external device. According to one embodiment, the external device is configured to determine one or more phrases silently spoke by the user from the silent speech signals by executing a neural network on the first and second silent speech signals.

According to one embodiment, the external device is configured to determine the one or more phrases by performing a comparison of results of executing the neural network on the first silent speech signals, executing the neural network on the second silent speech signals.

According to one aspect a system is provided. The system comprises the wearable device wherein the communication component is communicatively coupled to an external device and the external device wherein the external device is configured to receive one or more signals from the communication component. According to one embodiment, the wearable device is configured to transmit first silent speech signals based at least in part on electrical signals recorded by the first plurality of electrodes at a face of the user to the external device and second silent speech signals based at least in part on the signal indicative of the position of the tongue. According to one embodiment, the external device is configured to determine one or more phrases silently spoke by the user from the silent speech signals by executing a neural network on the first and second silent speech signals. According to one embodiment the communication component is communicatively coupled to an external device and the external device is configured to receive one or more signals from the communication component.

According to one embodiment, the wearable device is configured to transmit silent speech signals based at least in part on electrical signals recorded by the first plurality of electrodes at a face of the user to the external device and voiced speech signals based at least in part on signals recorded by the microphone. According to one embodiment, the external device is configured to perform training of a neural network based at least in part on a comparison of the silent speech signal and the voiced speech signal.

According to one embodiment, the wearable device is configured to transmit silent speech signals based at least in part on electrical signals recorded by the first plurality of electrodes at a face of the user to the external device and video signal based at least in part on signals recorded by the camera. According to one embodiment, the external device is configured to determine one or more phrases silently spoke by the user from the silent speech signals by executing a neural network on the silent speech signals and by executing a neural network on the video signal to determine one or more words phrases mouthed by the user.

According to one embodiment, the wearable device is configured to transmit silent speech signals based at least in part on electrical signals recorded by the first plurality of electrodes at a face of the user to the external device and motion signals recorded by the accelerometer. According to one embodiment, the external device is configured to determine one or more phrases silently spoke by the user from the silent speech signals by executing a neural network on the silent speech signals and by executing a neural network on the motion signals.

Still other aspects, examples, and advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples.” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF FIGURES

Various aspects of at least one embodiment are discussed herein with reference to the accompanying figures, which are not intended to be drawn to scale. The figures are included to provide illustration and a further understanding of the various aspects and embodiments and are incorporated in and constitute a part of this specification but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 is an example silent speech system, in accordance with some embodiments of the technology described herein.

FIG. 2A is an example flow diagram for data collected by a wearable device, in accordance with some embodiments of the technology described herein.

FIG. 2B is an example data processing process which may be performed by a wearable device, in accordance with some embodiments of the technology described herein.

FIG. 3A is an example is an example flow diagram for data processing within an external device having a machine learning model with multiple input layers, in accordance with some embodiments of the technology described herein.

FIG. 3B is an example is an example flow diagram for data processing within an external device having a machine learning model with multiple neural networks, in accordance with some embodiments of the technology described herein.

FIG. 3C is an example is an example flow diagram for data processing within an external device having a machine learning model which receives data at different layers, in accordance with some embodiments of the technology described herein.

FIG. 4A is an example data flow for controlling a wearable device using silent speech, in accordance with some embodiments of the technology described herein.

FIG. 4B is an example data flow for controlling a wearable device via an external device using silent speech, in accordance with some embodiments of the technology described herein.

FIG. 4C is an example data flow for controlling an external device using silent speech, in accordance with some embodiments of the technology described herein.

FIG. 4D is an example data flow for communication directly from a wearable device using silent speech, in accordance with some embodiments of the technology described herein.

FIG. 4E is an example data flow for communication via an external device using silent speech, in accordance with some embodiments of the technology described herein.

FIG. 4F is an example data flow for using an external device to analyze an environment using silent speech, in accordance with some embodiments of the technology described herein.

FIG. 4G is an example process for controlling a wearable device using silent speech, in accordance with some embodiments of the technology described herein.

FIG. 4H is an example process for controlling an external device using silent speech, in accordance with some embodiments of the technology described herein.

FIG. 4I is an example process for communication using silent speech, in accordance with some embodiments of the technology described herein.

FIG. 5A is a profile view of a user wearing an ear hook embodiment of a wearable device, in accordance with some embodiments of the technology described herein.

FIG. 5B is an illustration of wearable device target zones, in accordance with some embodiments of the technology described herein.

FIG. 5C is a side view of an ear hook embodiment of a wearable device, in accordance with some embodiments of the technology described herein.

FIG. 5D is a bottom view of an ear hook embodiment of a wearable device, in accordance with some embodiments of the technology described herein.

FIG. 5E is an inside view of an ear hook embodiment of a wearable device, in accordance with some embodiments of the technology described herein.

FIG. 5F is a profile view of a user wearing an ear hook embodiment of a wearable device with adjustments shown, in accordance with some embodiments of the technology described herein.

FIG. 5G is a top view of an ear hook embodiment of a wearable device with movability shown, in accordance with some embodiments of the technology described herein.

FIG. 5H is a top view of an ear hook embodiment of a wearable device from which detail view 5I is taken, in accordance with some embodiments of the technology described herein.

FIG. 5I is a detail top view of EMG electrodes of a wearable device with movability shown, in accordance with some embodiments of the technology described herein.

FIG. 6A is a view of a wearable device integrated into a helmet, in accordance with some embodiments of the technology described herein.

FIG. 6B is a view of a wearable device integrated into the chin strap of a helmet, in accordance with some embodiments of the technology described herein.

FIG. 6C is a rear view of a wearable device integrated into the chin strap of a helmet, in accordance with some embodiments of the technology described herein.

FIG. 7A is a view of a wearable device integrated into a full-face helmet, in accordance with some embodiments of the technology described herein.

FIG. 7B is a rear view of a wearable device integrated into a full-face helmet, in accordance with some embodiments of the technology described herein.

FIG. 8 is a view of a wearable device integrated into a headband, in accordance with some embodiments of the technology described herein.

FIG. 9 is a view of a wearable device integrated into smart glasses, in accordance with some embodiments of the technology described herein.

FIG. 10A is a view of a wearable device integrated into a headset, in accordance with some embodiments of the technology described herein.

FIG. 10B is an inside view of a wearable device integrated into a headset, in accordance with some embodiments of the technology described herein.

FIG. 10C is a view of a wearable device integrated into a headset with the movement of the sensor arm shown, in accordance with some embodiments of the technology described herein.

FIG. 11 is a view of a wearable device with two sensor arms on one side of a user's face, in accordance with some embodiments of the technology described herein.

FIG. 12 is a view of a wearable device with two sensor arms one on each side of a user's face, in accordance with some embodiments of the technology described herein.

FIG. 13 is a view of a wearable device a camera integrated into the sensor arm, in accordance with some embodiments of the technology described herein.

FIG. 14 is a view of a wearable device with two sensor arms on one side of a user's face with one of the sensor arms contacting the user's neck, in accordance with some embodiments of the technology described herein.

FIG. 15 is a view of a wearable device supported on the side of a user's face via an in ear speaker, in accordance with some embodiments of the technology described herein.

FIG. 16A is a view of a wearable device integrated into a smart mask, in accordance with some embodiments of the technology described herein.

FIG. 16B is a rear view of a wearable device integrated into a smart mask, in accordance with some embodiments of the technology described herein.

FIG. 17 illustrates a system in which a wearable device is used to control a connected external device, in accordance with some embodiments of the technology described herein.

FIG. 18 illustrates a system in which a wearable device may be used in conjunction with an external device to obtain information about the environment of the user, in accordance with some embodiments of the technology described herein.

FIG. 19 illustrates an example of a system in which a wearable device is used for communication with one or more individuals, in accordance with some embodiments of the technology described herein.

FIG. 20 illustrates an example of a system in which a wearable device is used for video conferencing with one or more individuals, in accordance with some embodiments of the technology described herein.

### DETAILED DESCRIPTION

To solve the above-described technical problems and/or other technical problems, the inventors have recognized and appreciated that silent speech or sub-vocalized speech may be particularly useful in communication and may be implemented in in interactive systems. In these systems, for example, users may talk to the system via silent speech or whisper to the system in a low voice for the purposes for providing input to the system and/or controlling the system.

In at least some embodiments as discussed herein, silent speech is speech in which the speaker does not vocalize their words out loud, but instead mouths the words as if they were speaking with vocalization. These systems could enable users to enter a prompt by speech or communicate silently, but do not have the aforementioned drawbacks associated with voice-based systems.

Accordingly, the inventors have developed new technologies for interacting with mobile devices, smart devices, communication systems and interactive systems. In some embodiments, the techniques may include a (silent) speech model configured to convert an electrical signal generated from a speech input device to text, where the electrical signal may be indicative of a user's facial muscle movement when the user is speaking (e.g., silently or with voice). The speech input device may be a wearable device.

The techniques are also provided that include novel approaches in which a silent speech model may be trained and configured to convert an electrical signal indicative of a user's facial muscle movement when the user is speaking, such as EMG data, to text or other input type (e.g., control input). The silent speech model may be used to control an interactive system or to communicate with a system, device or other individual. In some embodiments, the techniques are provided that also use one or more additional sensors to capture other sensor data when the user is speaking, such as voice data. The other sensor data may be combined with the EMG data to improve the accuracy of the generated text.

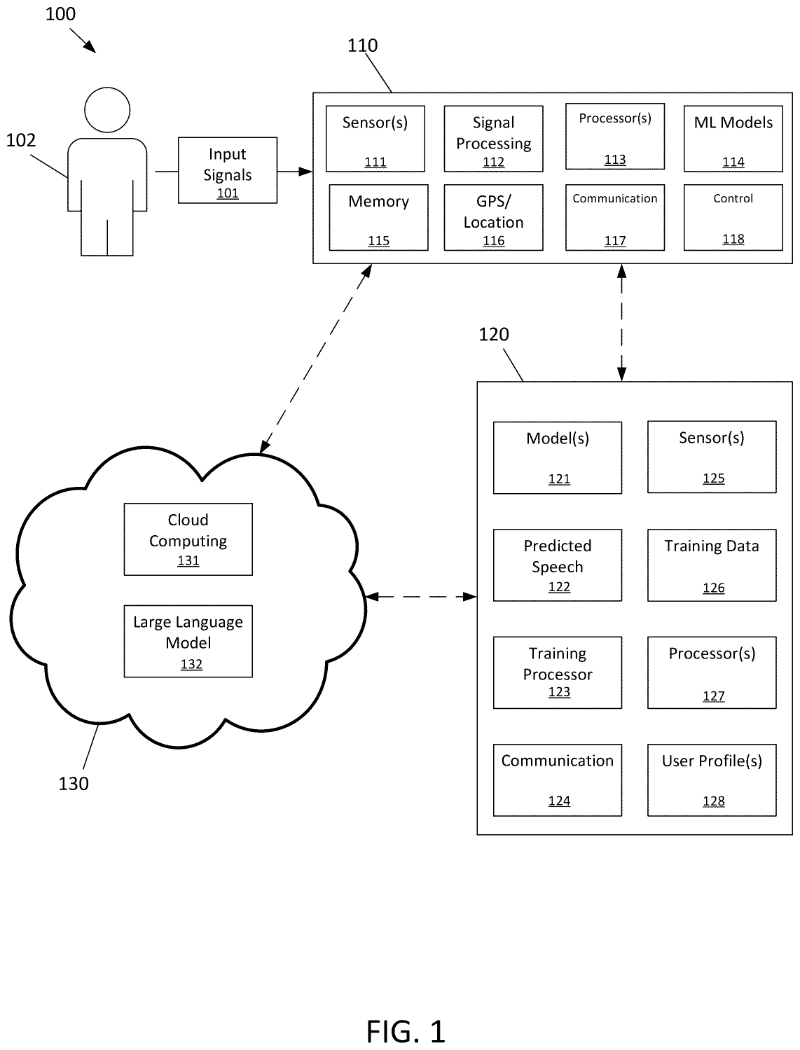

FIG. 1, is a block diagram of a silent speech system 100, in accordance with some embodiments of the technology described herein. The silent speech system 100 may include a wearable silent speech device 110 configured to record silent speech signals 101 of a user 102, an external device 120 configured to determine words or phrases from silent speech signals 101 recorded by the wearable device, and a server 130.

Specific modules are shown within each of the external device 120 and server 130, however these modules may be located within any of the wearable device 110, external device 120 and server 130. In some examples, the external device 120 may contain the modules of the server 130 and the wearable device 110 will communicate directly with the external device 120. In some examples, the server 130 may contain the modules on the external device 120 and the wearable device 110 will communicate directly with the server 130. In some examples, the wearable device 110 may contain the modules of both the external device 120 and the server 130 and therefore the wearable device 110 will not communicate with the external device 120 or the server 130 to determine one or more words or phrases from the signals 101 recorded by the wearable device. In some examples some modules of the server 130 and external device 120 may be included in the server 130, external device 120 and/or the wearable device 110. Any combination of modules of the server 130 or external device 120 may be contained within the server 130, the external device 120 and/or the wearable device 110.

The wearable silent speech device 110 may include one or more sensors 111 which are used to record input signals 101 form a user. The sensors 111 may include EMG electrodes for recording muscle activity associated with speech, a microphone for recording voiced and/or whispered speech, an accelerometer or IMU for recording motion associated with speech and other sensors for recording signals associated with speech. These other sensors may measure a position of a user's tongue, blood flow of the user, muscle strain of the user, muscle frequencies of the user, temperatures of the user, and magnetic fields of the user, among other signals, and may include: photoplethysogram sensors, photodiodes, optical sensors, laser doppler imaging, mechanomyography sensors, sonomyography sensors, ultrasound sensors, infrared sensors, Functional near-infrared spectroscopy (fNIRS) sensors, capacitive sensors, electroglottography sensors, electroencephalogram (EEG) sensors, and Magnetoencephalography (MEG) sensors, among other sensors.

The sensors 111 may be supported by the wearable device to record signals 101 associated with speech, either silent or voiced, at or near the wearers 102 head, face and/or neck. Once recorded the signals 111 may be sent to a signal processing module 112 of the wearable device 110. The signal processing module 112 may perform one or more operations on the signals including filtering, and analog to digital conversion, among other operations.

The signal processing module 112 may then pass the signals to one or more processors 113 of the wearable device 110. The processors 113 may perform additional processing on the signals including preprocessing, and digital processing. In addition, the processors may utilize one or more machine learning models 114 stored within the wearable device 110 to process the signals. The machine learning models 114 may be used to perform operations including feature extraction, and downsampling, as well as other processes for recognizing one or more words or phrases from signals 101.

The wearable device may additionally include memory 115 and GPS and Location sensors 116. Memory 115 may maintain data necessary to perform general functions and operations of the wearable device 110. Data from the GPS and Location sensors 116 may be used in combination with signals 101 in some functions of the wearable device 110.

Processed signals may be sent to communication module 117. The communication module 117 may perform one or more operations on the processed signals to prepare the signals for transmission to one or more external devices or systems. The signals may be transmitted using one or more modalities, including but not limited to wired connection, Bluetooth, Wi-Fi, cellular network, Ant, Ant+, NFMI and SRW, among other modalities. The signals may be communicated to an external processing device and/or to a server for further processing and/or actions.

The one or more external devices or systems may be any device suitable for processing silent speech signals including smartphones, tablets, computers, purpose-built processing devices, wearable electronic devices, and cloud computing servers, among others. In some examples, the communication module 117 may transmit speech signals directly to a server 130, which is configured to process the speech signals. In some examples, the communication module 117 may transmit speech signals to an external device 120 which processes the signals directly. In some examples, the communication module 117 may transmit speech signals to an external device 120 which, in turn, transmits the signals to server 130 which is configured to process the speech signals. In some examples, the communication module 117 may transmit speech signals to an external device 120 which is configured to partially process the speech signals and transmit the processed speech signals to a server 130 which is configured to complete the processing of the speech signals. The wearable device 110 may receive one or more signals from the external device or the cloud computing system in response to any transmitted signals.

Wearable device 110 may also include control module 118, which may be used to control one or more aspects of the device. For example, the control module 118 may function to select sensors 111 for recording of signals, select subsets of a particular sensor such as electrodes for recording, change one or more modes of the wearable device 110, activate one or more modules of the wearable device 110 in response to an activation signal, and control the recording of signals among other functions. In some examples the control module 118 may be configured to activate the signal processing module and processors in response to an activation signal recorded by one or more of sensors 111. The activation signal may be one or more particular words or phrases which are recognized by the wearable device 110. Activation signals may be recognized by the signal processing module 112, processors 113, or by using the machine learning models 114.

The external device 120 may include a communication module 124 to retrieve and transmit signals to the wearable device 110 or the server 130. The external device 120 may include a predicted speech module 122 configured to perform processing to determine one or more words or phrases spoke, either voiced or silently, from the signals received from the wearable device 110. The external device 120 may store one or more models 121 which may be used by the predicted speech module in determining the one or more words or phrases. The models 121 may receive as inputs, the signals received from the wearable device, and output one or more determined words or phrases. The one or more models 121 may be trained on training data 126 stored within the external device or accessible by the external device. The external device 120 may additionally include a training processor 123, which updates models 121 based on signals received from the wearable device 110 and maintained training data 126. The one or more models 121 may additionally be dependent on one or more user profiles 128 maintained by the external device. The user profiles 126 may contain information related to one or more particular users of the device. For example, user 102 may have an individual user profile maintained by the external device 120. The information contained within user profiles 126 may improve the accuracy of the models 121 in determining one or more words or phrases, based on characteristics of the particular user.

After determining the one or more words or phrases, the external device 120 may then perform one or more actions in response to the determined words or phrases. In some examples, the processors 127 of the external device 120 may perform natural language processing on the one or more words or phrases to determine an action to perform in response to the words or phrases. The external device may then perform the action determined by natural language processing. In some examples, the processors 127 of the external device 120 may convert the one or more words or phrases to an audio signal. The audio signal may be played using a speaker of the external device or may be sent to other devices by communication module 124. In some examples, the audio signal may be played back to the user using a speaker of the wearable device 110. The audio may be sent to other devices using any suitable modality. In some examples, the other devices may be connected to the same network as the external device 120 and transmit the audio signal via the network. In some examples the other devices may send a response signal to the external device 120 directly. The response signal may be sent from the external device 120 to the wearable device 110. In some examples, the response signal may be sent directly from the other devices to the wearable device 110.

Server 130 may include cloud computing module(s) 131 and a large language model 132 for completing processes as discussed here.

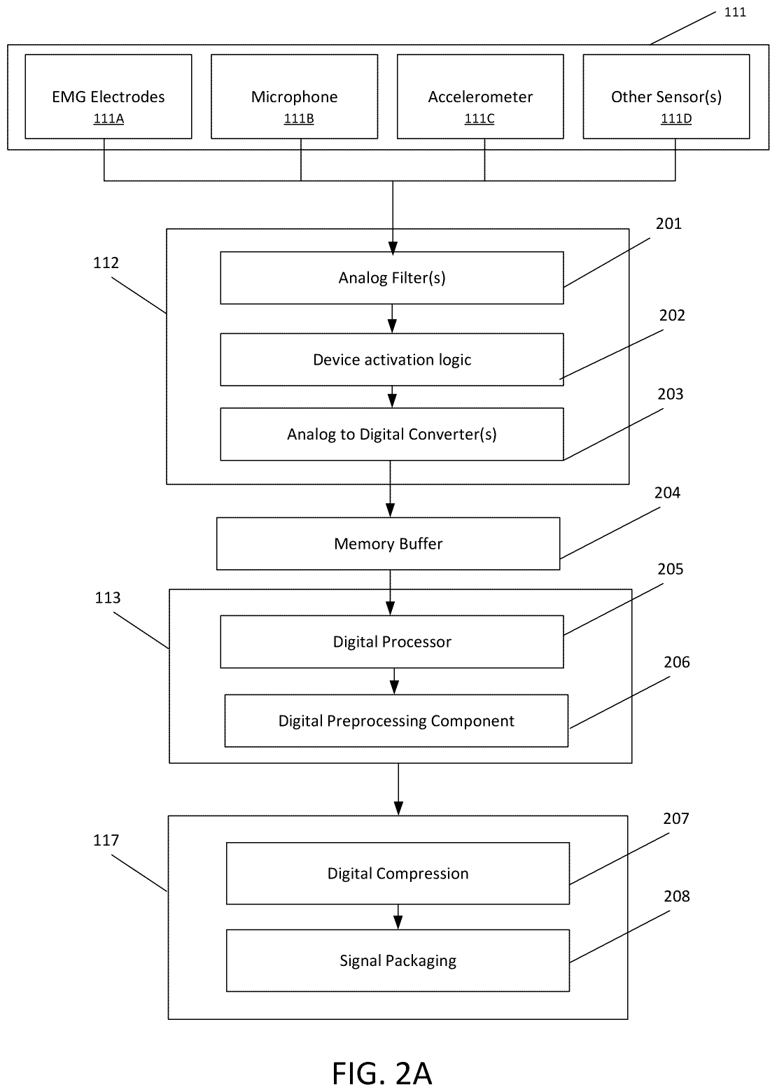

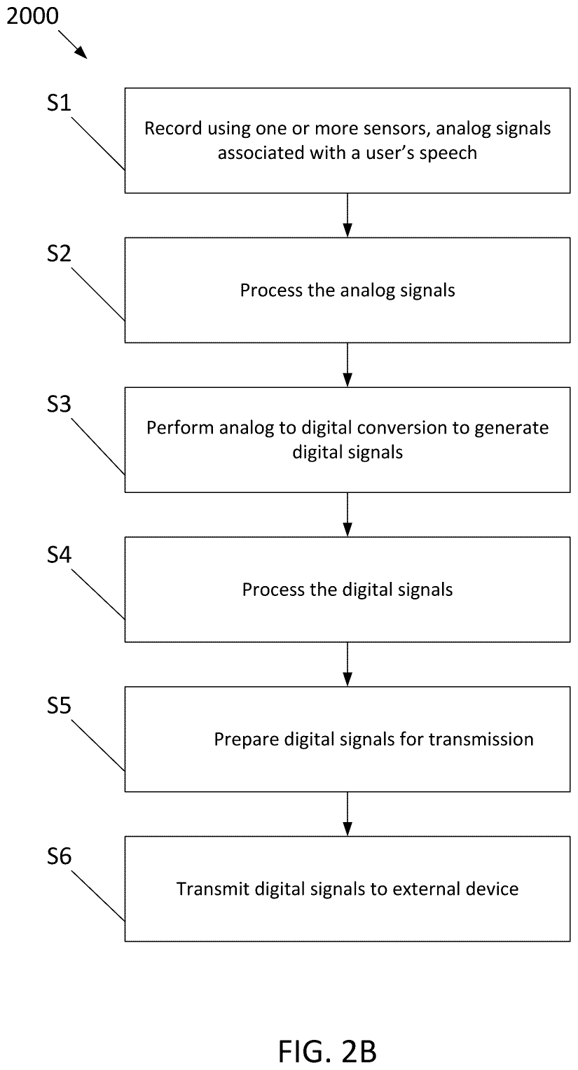

FIG. 2A illustrates a diagram of an exemplary flow of information within a wearable device 110, in accordance with some embodiments of the technology described herein. At the top of the diagram are sensors 111 which record signals from the user. Exemplary sensors 111 are described herein. Shown are one or more EMG electrodes 111A, a microphone 111B, an accelerometer 111C and other sensors 111D. The signals collected from the sensors may be analog signals which are then sent to the signal processing module of the wearable device.

The signal processing module 112 and processors 113 may perform a series of processes on the signals received from the sensors. FIG. 2A depicts a series of processes which may be performed on the signals. The processes shown in FIG. 2A may be performed in any suitable combination or order. Each signal may have an associated series of processing steps tailored to that particular signal. Different signals may be processed in a series of different steps. For example, signals from the EMG electrodes may undergo all steps shown in FIG. 2A, while signals from the microphone may only undergo analog to digital conversion and digital processing. The processing performed at each of the processing steps of the series of processing steps may be different for each signal received from the sensors. For example, the analog filters may include a high-pass filter for signals received from the microphone, while a bandpass filter may be used on signals received from the EMG electrodes.

The signal processing module 112 may include one or more analog filters 201. The analog filters 201 may be used to improve the quality of the signals for later processing. The analog filters 201 may include any suitable filter including a high-pass filter, a low-pass filter, a bandpass filter, a moving average filter, a band stop filter, a Butterworth filter, an elliptic filter, a Bessel filter, a comb filter, and a gaussian filter, among other suitable filters. The analog filters 201 may be implemented as circuitry within the wearable device.

After analog filtering, the signals may be passed to device activation logic 202, which analyzes the filtered analog signals. The device activation logic 202 may analyze the filtered signals to determine the presence of one or more activation signals recognized from the analog signals. For example, a user may say a particular word or phrase out loud, which is recorded by the microphone. The device activation logic 202 may recognize this word or phrase and in response will perform one or more actions. The one or more actions may include changing a mode of the device, activating one or more features of the device, and performing one or more actions. The device activation logic 202 may analyze analog filtered signals as shown, unfiltered analog signals, digital signals, filtered digital signals and/or any other signal recorded from the one or more sensors. The device activation 202 logic may operate on signals from any of the sensors including the EMG electrodes 111A, the accelerometer 111C, the microphone 111B and any other sensors 111D present in the wearable device 110. The device activation logic 202 may be implemented in any suitable component of the wearable device including signal processing modules 112 and processors 113.

Analog signals may be passed to one or more analog to digital converters 203, which convert the analog signals to digital signals. The signals input to the analog to digital converters may be filtered or unfiltered signals. There may be individual analog to digital converters for each sensor. The one or more analog to digital converters 203 may be implemented as circuitry within the wearable device 110. Any suitable analog to digital converter circuit configuration may be used.

There may be one or more memory buffers 204 contained within the wearable device 110. The memory buffers 204 may temporarily store data as it is transferred between the signal processing module 112 and one or more processors 113 of the wearable device 110, or between any other modules of the wearable device 113. The memory buffers 205 may be implemented as hardware modules or may be implemented as software programs which store the data in a particular location within the memory 115 of the wearable device 110. The memory buffers 204 may store data including signals, processed signals, filtered signals, control signals and any other data from within the wearable device 110.

The digital signals may be processed at one or more digital signal processors 205, in order to improve quality for later processes. The digital signals may undergo one or more digital processing steps. The digital processing may be tailored to specific signals, for example signals from the EMG electrodes may undergo specific digital processing, different from processing executed on signals recorded from the microphone. Examples of digital signal processing may include digital filtering of the signals, feature extraction, Fourier analysis of signals, and Z-plane analysis, among other processing techniques. In some examples the digital signals may be processed using one or more layers of a neural network, and/or a machine learning model maintained by the wearable device 110 to generate a digital signals vector. The digital signals may additionally undergo preprocessing by digital preprocessing module 206, in which the data is transformed for later analysis. Preprocessing may include normalization of data, cropping of data, sizing of data, and reshaping of data, among other preprocessing actions.

The wearable device may perform additional processing on the signals, not pictured in FIG. 2A. For example, the signal processing module 112 may perform feature extraction of analog signals recorded from sensors 111, process analog signals using a machine learning model maintained by the wearable device 110 and may perform one or more layers of a neural network on analog signals recorded from sensors 111 to generate an analog signal vector.

After processing of the signals is completed by the one or more processors 113, the processed signals may be sent to the communication module 117. Within the communication module 117, signals may undergo digital compression and signal packaging by respective digital compression 207 and signal packaging 208 modules. Digital compression may be performed on one or more signals in order to reduce the amount of data transmitted by the wearable device. The digital compression module 207 may use any suitable technique to compress signals including both lossy and lossless compression techniques. Signal packaging may be performed to format a signal for transmission according to a particular transmission modality. For example, a signal may be formatted with additional information to form a complete Bluetooth packet for transmission to an external device. Signals may be packaged in a variety of ways, which vary according to the transmission modality used to send the signal.

FIG. 2B illustrates a method 2000 which may be performed by wearable device 110 to record and process signals before transmission to an external device. The method of FIG. 2B begins at step S1, where one or more sensors of the device are used to record speech signals from a user. The step may be performed using any sensors as described herein, including EMG electrodes, microphones, and accelerometers, among other sensors. The signal recorded from the sensors may be analog signals, which are processed in step S2.

The analog signals may be processed in step S2, as discussed with regard to FIG. 2A. Processing may include performing filtering, feature extraction, device activation logic, and machine learning processing, among other techniques. In step S3, the processed analog signals are converted to digital signals using analog to digital conversion, as discussed herein.

In step S4, digital signals may be processed. Processing of digital signals may include digital filtering of the signals, feature extraction, Fourier analysis of signals, machine learning processing and Z-plane analysis, among other processing techniques. The processing techniques described with regard to FIG. 2A may be used to process digital signals.

In step S5 the digital signals are prepared for transmission. Step S5 may involve preprocessing signals, compressing signals and packaging signals as discussed herein. Method 2000 ends at step S6 where the digital signals are transmitted to an external device. The signals may be transmitted using any suitable modality, as discussed herein. In embodiments where the wearable device is configured to determine words or phrases from the speech signal, steps S4 and S5 may not be performed, and digital signals may be sent directly to device components for determining the words or phrases.

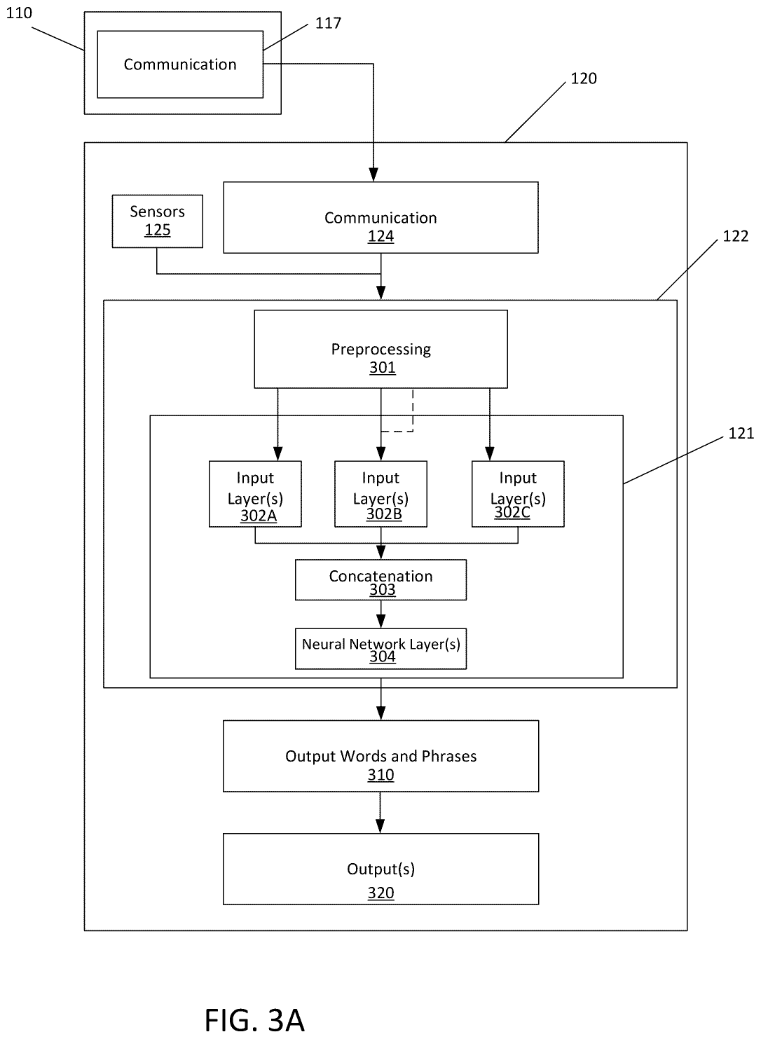

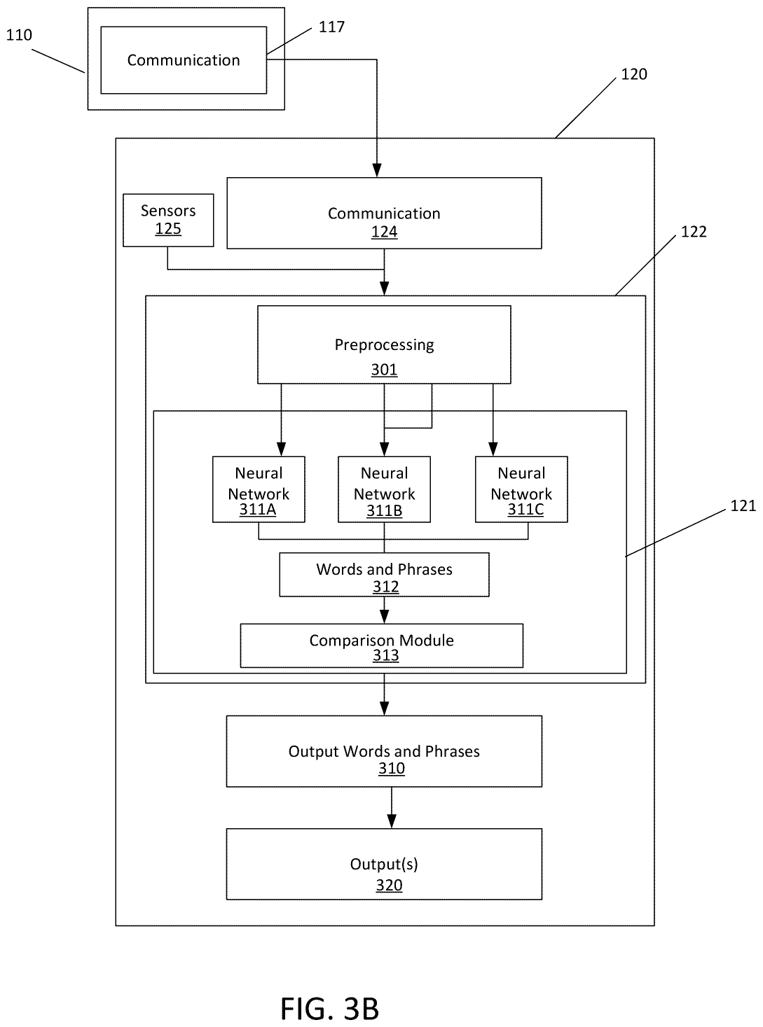

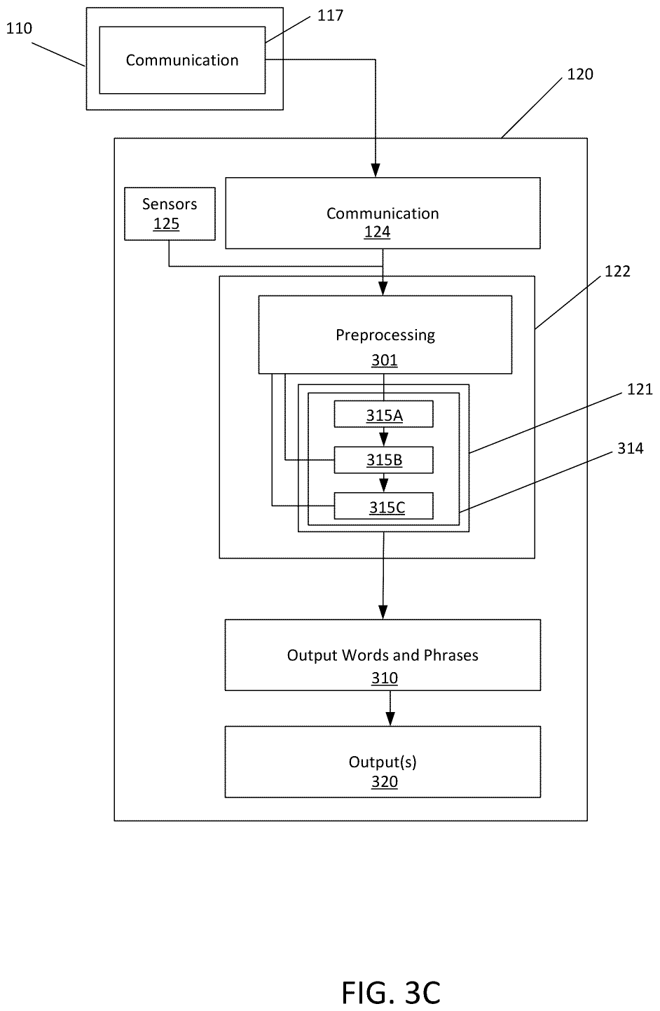

FIG. 3 shows a diagram of the components of an external device 120, in accordance with some embodiments of the technology described herein. The external device 120 may receive signals from the communication module 117 of the wearable device. The received signals may have undergone processing as discussed with relation to FIG. 2A, including filtering, analog to digital conversion, digital processing and preprocessing, among other suitable processing techniques. The signals transmitted from the wearable device may be received at a communication module 124 of the external device 120. The communication module 124 may perform one or more actions on the received signals then pass these signals to one or more predicted speech modules 122, which process the signals and output a speech prediction based on the signals.

Within the predicted speech module 122, signals may undergo one or more preprocessing actions performed by preprocessing module 301. The preprocessing actions may include formatting the data from the signals into a structure suitable for later analysis, for example the preprocessing in the predicted speech module 122 may combine multiple signals, such as signals from multiple sensors of the wearable device, into a single data structure. The preprocessing actions may also include any other suitable actions for processing or preparing the signals for further analysis.

The signals may then be processed using one or more machine learning models 121 maintained by the external device 120. The machine learning models 121 may be accessed by the predicted speech module 122 for processing and may be used to determine one or more output words or phrases 310 from the signals. The machine learning models 121 may be trained on training data stored 126 within the external device 120 and/or may be trained on data collected by the wearable device 110. The machine learning models may be structured in a variety of ways.

In some examples, such as that shown in FIG. 3A, the machine learning model 121 may be structured as a neural network with one or more sets of layers. A first set of layers may include input layers 302A, 302B and 302C, specific to each of the signals received from the wearable device. For example, signal data associated with the EMG electrodes may be passed to a first group of input layers 302A and the signal data from the accelerometer may be passed to a second group of input layers 302B, separate from the first group of input layers 302A. The input layers for a particular type of sensor signal data may be trained specifically on that type of data and may function to extract features from the signals received from the wearable device 110. These features may be indicative of parts of speech which can be identified in the signal.

In some examples, input layers may be configured to receive as inputs multiple types of data, as shown by the input to 302B. In such examples, the input data may be from multiple sensors on wearable device 110, for example 302B may receive as inputs data from the accelerometer and data from an ultrasound sensor. Although three input layer group are shown, any suitable number of input layers may be used, and there may be as many input layer groups as sensors on the wearable device 110. The input layers for a particular signal may include convolutional layers, feedforward layers, transformer layers, conformer layers, and recurrent layers, among other types of neural network layers.

After processing signals at the signal-specific input layers, the features extracted from the signals may be concatenated at 303 into a single data structure which is passed to a second set of one or more neural network layers 304. The second set of layers 304 may be trained on feature data from multiple signal sources, including all sensors contained within the wearable device. The second set of neural network layers 304 may output one or more predicted words or phrases 310 determined from the features provided as inputs to one or more output processes 320 to be carried out by the external device in response to the output words and phrases.

In some examples, such as that shown in FIG. 3B, the machine learning model may contain multiple, separate neural networks 311A, 311B and 311C. The separate neural networks may be structured to take as inputs a single type of signal data, for example only signal data from the EMG electrodes. The separate neural networks may be structured to take as inputs multiple types of signal data for example, signal data from an accelerometer and from an ultrasound sensor. Although three neural networks are shown, any suitable number of neural networks may be used, and there may be as many neural networks as sensors on the wearable device 110.

The separate neural networks may be structured to have multiple sets of layers, for example a set of input layers which extract features from individual signal data and a second set of layers which determine one or more predicted words or phrases from concatenated feature data from the input layers. The separate neural networks may be structured to have multiple sets of layers, for example input layers which extract features from multiple types of signal data and a second set of layers which output one or more predicted words or phrases from concatenated feature data from the input layers. The layers of the separate neural networks may be structured as convolutional layers, feedforward layers, transformer layers, conformer layers, and recurrent layers, among other types of neural network layers.

The predicted words and phrases 312 from the separate neural networks may then be fed to a comparison module 313. The comparison module 313 may perform a comparison of the one or more predicted words or phrases 312 to determine output predicted words or phrases 310. The comparison may be performed by a vote on the outputs from each of the separate neural networks 311A, 311B and 311C. The vote may be a majority vote, where the words or phrases occurring the most in the outputs is determined to be included in the output words and phrases. The comparison may be performed by a weighted vote, where the outputs of particular neural networks are weighted differently based on one or more factors, and the words or phrases receiving the highest weighed voting score are included in the output predicted words and phrases. The outputs 312 of neural networks may be weighted based on the accuracy, reliability, quality, and/or availability of the sensor which the network is configured to process data for.

In some examples, such as that shown in FIG. 3C, the machine learning model 121 may be structured as a single neural network 314 where different signals are introduced at different layers of the neural network. For example, data associated with the EMG electrodes may be provided to a first layer or set of layers 315A which process the data and send the processed data to a second set of layers 315B. Data associated with the accelerometer may be provided to the second set of layers 315B, and this data may be processed in conjunction with the data from the first layers. The processed data from the second set of layers may be passed to a third set of layers 315C, which may receive additional data such as data associated with ultrasound sensors of the wearable device. The neural network 314 may include additional layers and may receive additional data for processing at these additional layers. The neural network may output one or more predicted words or phrases 310.

The machine learning model 121 may be structured in other ways known to those skilled in the art. For example, the machine learning model 121 may contain combinations of features of one or more of the previously described examples. In some examples, the machine learning model may be structured to have outputs other than one or more predicted words or phrases, for example the machine learning model may be configured to output audio signals corresponding to one or more words or phrases silently spoke by the user, these audio signals may be used in the same functions as discussed herein. In some examples, the machine learning model may output one or more processed signals which correlate to one or more actions to be performed at an output process as discussed herein.

In some examples, such as those of FIGS. 3A, 3B and 3C, the machine learning model may determine the one or more predicted words or phrases based on previously determined predicted words or phrases.

In some examples, such as those of FIGS. 3A, 3B and 3C, the external device may contain one or more sensors 125 which may be used in the determination of silent speech signals. These sensors 125 may include a camera, a microphone, time of flight sensors, and infrared sensors among other sensors. Data from the one or more sensors 125 of the external device may be processed in the same manner as data received from the wearable device, according to the examples described above, in order to determine the one or more output words or phrases 310.

After the one or more output words and phrases are determined, they may be sent to one or more output processes 320 of the external device 120. Such outputs are described in relation to specific functions and use examples of the silent speech system.

One function of the system may be to control one or more aspects of the wearable device. The wearable device may record signals from the user. The signals may include silent speech signals indicative of the user mouthing words or phrases without speaking the words or phrases out loud. The signals may additionally include voiced signals which are indicative of the user speaking words or phrases out loud. In some examples, the user may speak, either silently or voiced, a specific command to control a mode of the wearable device. For example, the user may speak out loud “switch to voiced speech mode” after which the wearable device may begin recording from only the microphone. The user may then speak out loud “switch to silent speech mode”, after which the wearable device may begin recording from other sensors such as the EMG electrodes and/or accelerators. The wearable device may also be turned on, turned off, have processing components activated, have sensors activated or deactivated, be switched to a pairing mode, be paired to an external device, and perform other actions, in response to specific voiced or silent speech signals.

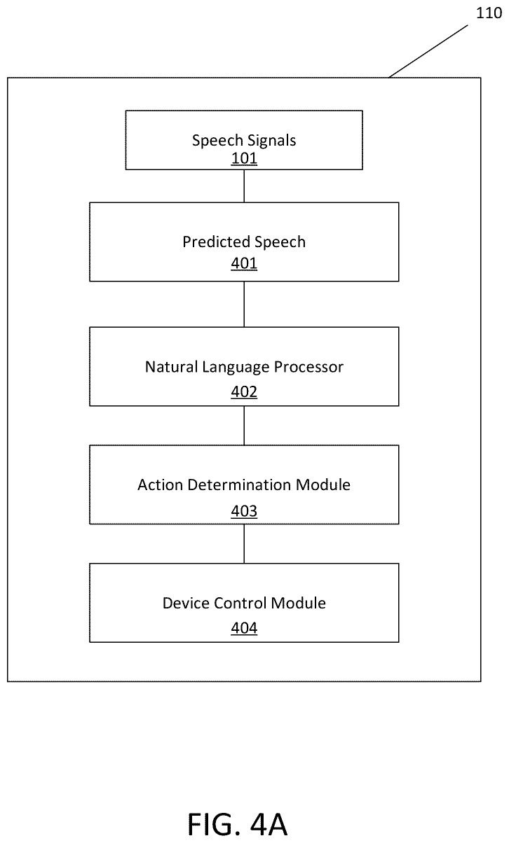

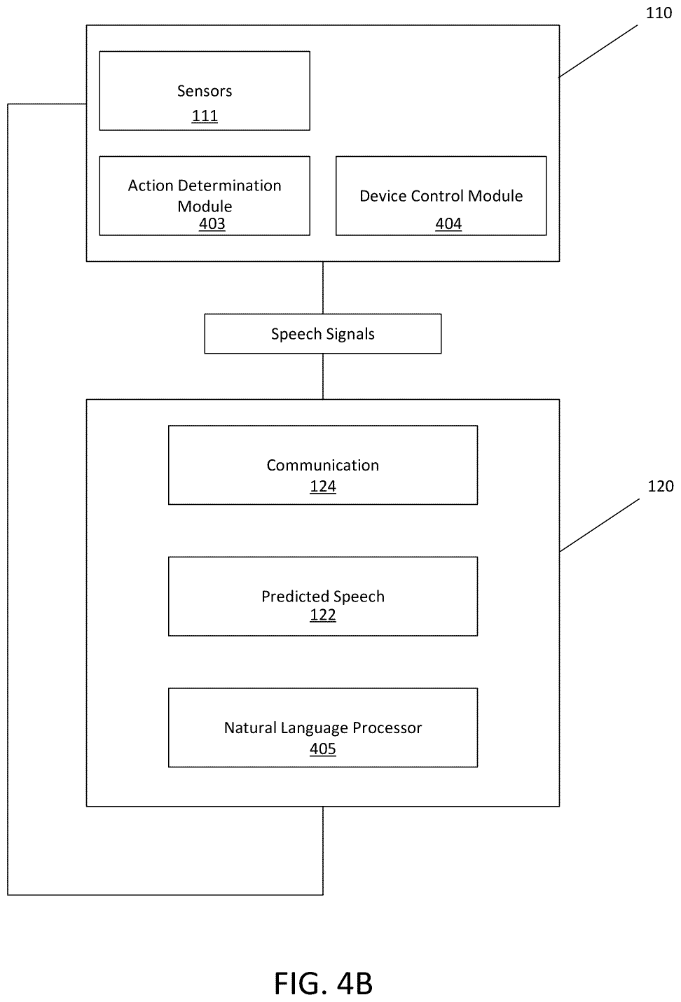

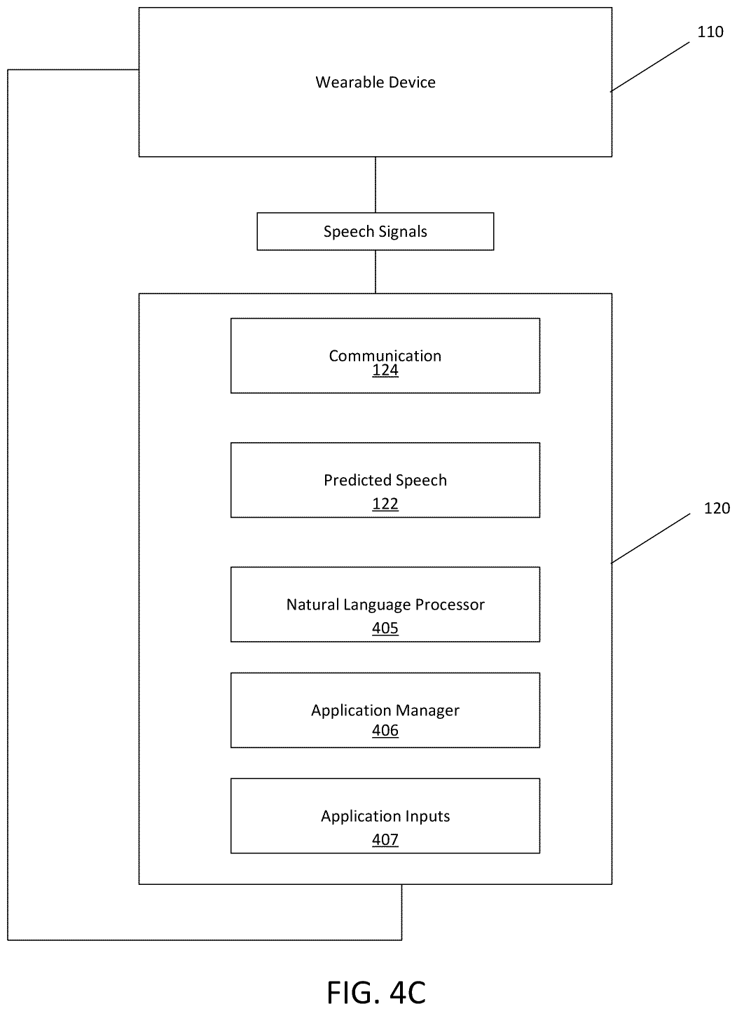

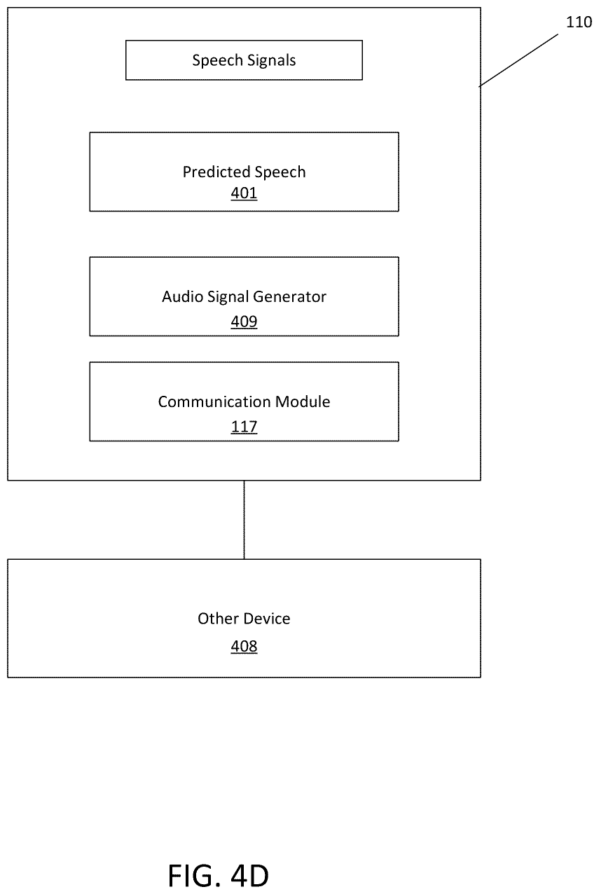

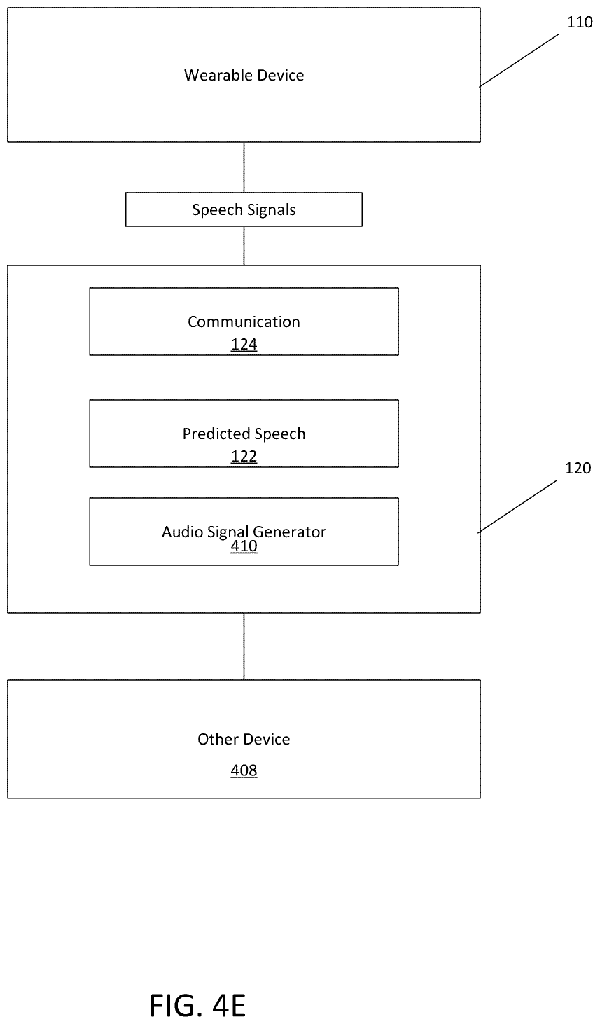

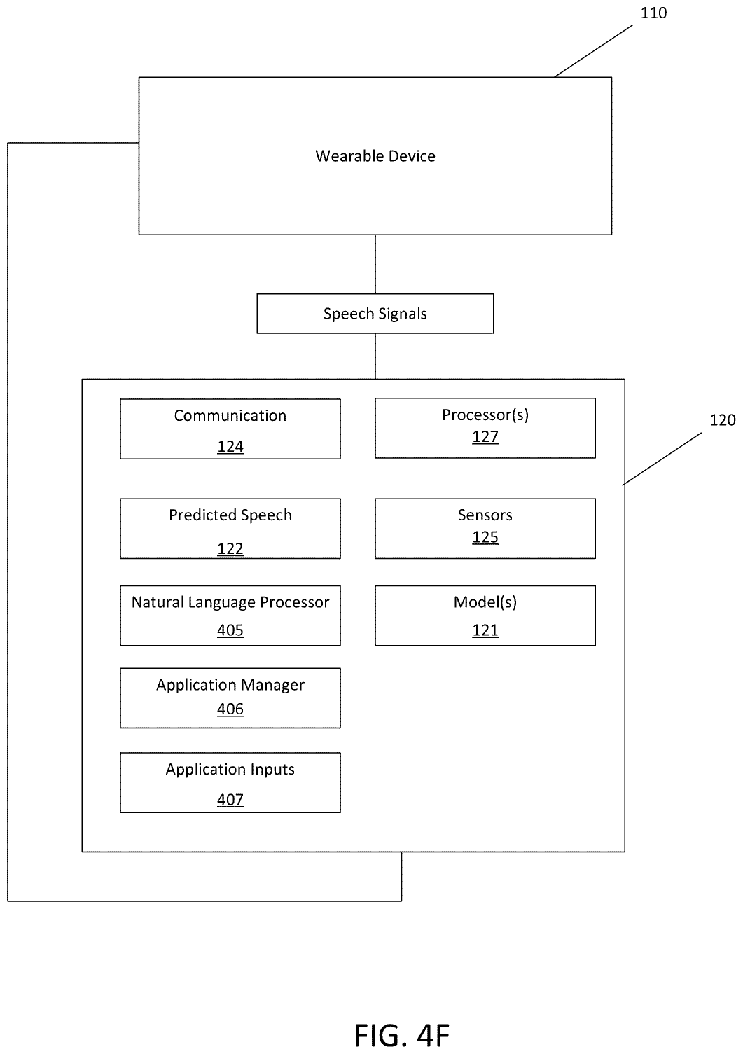

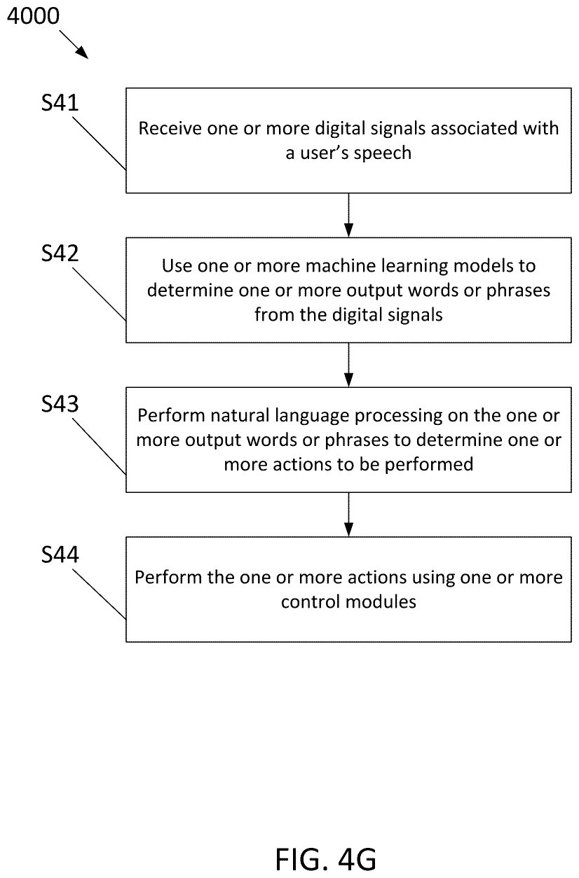

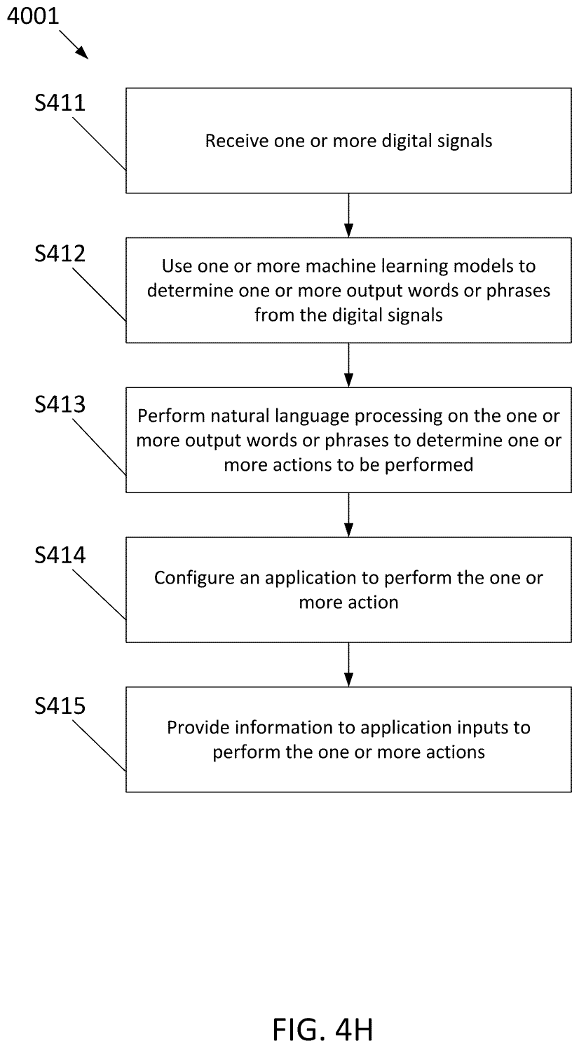

FIG. 4A illustrates an example of a wearable device 110 configured to change modes in response to speech signals. For the device to change modes in response to specific voiced or silent speech signals 101, the wearable device 110 must recognize the specific speech signals 101. This may be accomplished by one or more predicted speech processing modules 401 on the device which are configured to recognize the specific speech signals. These processing modules 401 may be capable of recognizing the specific speech signals from analog signals recorded from the sensors and/or from digital signals, as discussed herein. In some examples the wearable device may contain a machine learning model which determines one or more words or phrases from the speech signals, according to techniques described herein.

The output words or phrases may be analyzed by one or more natural language processors 402 of the wearable device 110 to determine if the output words or phrases are associated with a command to control the wearable device. The wearable device may be configured to determine an action to be performed in response to the output words or phrases being associated with a command to control the wearable device, using action determination module 403. The action determination module may send the action to be performed to device control module 404 which will control the wearable device 110 to perform the actions.

FIG. 4B illustrates an example of a silent speech system 100 in which the wearable device transmits speech signals 101 to an external device 120, which transmits one or more commands to the wearable device 110 in response to the silent speech signals 101. In some examples, the wearable device 110 may transmit the recorded and processed speech signals 101 to an external device 120, as discussed herein, which may determine one or more output words or phrases from the recorded signals. The one or more output words or phrases may be determined using predicted speech module 122, as discussed herein. The output words or phrases may be transmitted to the wearable device 110, where they are analyzed to determine if the output words or phrases match one or more specific commands as discussed herein. In some examples the external device may determine if the output words or phrases are associated with one or more specific commands, using one or more natural language processors 405, and in response to determining the output words or phrase are associate with a specific command, transmits the command to the wearable device 110. The wearable device may change modes in response to the command as discussed herein, using action determination module 403 and device control module 404.

In some examples, the wearable device 110 or external device 120 may determine if the output words or phrases match a specific command by performing a comparison between the one or more words and phrases and words or phrases associated with a specific command. The words or phrases associated with the specific command may be maintained in memory of the wearable device or the external device. If the comparison indicates a degree of matching above a threshold amount of matching, the wearable device may execute one or more actions in response.

A second function of the system may be to control one or more aspects of an external device. The user may silently speak a command which is recorded by the wearable device, the signals may be transmitted to an external device which determines one or more output words or phrases as discussed herein. The one or more output words or phrases may be sent to a natural language processing module of the external device. The natural language processing module of the external device may analyze the output words or phrases to determine an action to be performed by the external device.

FIG. 4C illustrates an example of a silent speech system in which silent speech signals may be used to control one or more aspects of an external device. For example, a user interface of the device may be controlled in response to the determined actions. The user interface may display one or more elements, which a user may select or interact with, such as a camera icon which the user would like to open. The predicted speech module 122 of the external device 120 may identify “open camera application” as an output phrase which is passed to the natural language processing module 405. The natural language processing module 405 may determine an action to be performed based on the output phrase. In response to the action the application manager 406 of the external device 110 may run the camera application and display the camera application on a user interface of the device.

For example, the determined actions may be used to control applications of the external device. The external device may identify an output phrase “take picture” and perform natural language processing on the phrase. In response to the natural language processing output action, the external device may perform the process of capturing a picture in the camera application by providing information about the action to application inputs 407.

For example, the determined actions may be used to provide inputs to applications of the device. Some applications such as messaging, and word processing applications require user input during regular use. In an example in which a user desires to input words into a word processing document, the predicted speech module 122 of the external device may identify as an output phrase “begin dictation.” Based on natural language processing of the phrase, performed by natural language processor 405, an action may be determined to begin inputting dictated language into an input portion of the word processing document. The external device may provide an indication to the user that they may begin dictating, such as a sound to be played on the speaker of the wearable device and/or an indication on the user interface of the external device. The user may then silently speak, which will be recorded by the wearable device and converted to output words or phrases by the predicted speech module 122 of the external device 120. The output words or phrases may be populated within the word processing document via the application manager 406 and application inputs 407.

For example, the external device may support a personal assistant and/or voice command function and the determined actions may be used to activate these features of the external device. If a user desires to activate a personal assistant, the predicted speech module 122 of the external device 120 may identify as an output phrase “hey assistant” which will result in the natural language processor 405 to output an action to the application manager 406 which activates the personal assistant function of the device. The user may then silently speak one or more commands which are recorded by the wearable device and result in output words or phrases determined by the external device. The output words or phrases may be provided as an input to the personal assistant of the device as application inputs 407.

A third function of the system may be to support communication between the user and one or more individuals. The output words or phrases may be transmitted to an audio generation module which generates an audio signal based on the output words or phrases. This audio signal may then be transmitted to the device of an individual in communication with the user.

FIG. 4D illustrates an example of a silent speech system in which silent speech signals recorded and processed by a wearable device may be used for communication. The wearable device 110 may be connected to another device 408 such as a cellular phone. The user may silently speak one or more words or phrases, which are processed by the predicted speech module 401 to one or more output words or phrases. The output words or phrases may be passed to an audio signal generator 409 which converts the one or more words or phrases to an audio signal. The audio signal may contain the one or more output words or phrases as speech. The audio signal may be passed to a communication module which processes the signal and transmits the audio signal to the other device 408.

FIG. 4E illustrates an example of a silent speech system in which silent speech signals recorded by a wearable device and are processed by an external device for communication with one or more other devices. In some examples, external device 120 may be a cellular phone comprising a predicted speech module 122 which may determine one or more output words or phrases from silent speech signals received from wearable device 110. The external device 120 may also contain an audio signal generator 410 which may convert the one or more output or phrases to an audio signal as discussed herein. The external device may convert silent speech signals to an audio signal during a phone call, and a communication module 124 may transmit the audio signal to another phone or device 408. In some embodiments, the wearable device 110 may determine the output words or phrases and the audio signal which are transmitted to the cellular phone 120 of the user. In some embodiments, the wearable device 110 may determine the output words or phrases and the audio signal which are transmitted directly to the other device 408 of the individual in communication with the user.

As discussed herein, the machine learning model 121 of predicted speech module 122 may be configured to output audio signals corresponding to one or more words or phrases silently spoke by the user, and in such examples audio signal generator 410 may not be included in the external device 120.

In some examples, the wearable device 120 may be paired with an external device 408 which supports video conferencing. During a video conference, the external device 120 may determine the output words or phrases and generate an audio signal based on the output words or phrases, as discussed herein. The audio signal is then transmitted to the other devices 408 participating in the video conference. In some embodiments, the wearable device 110 may determine the output words or phrases and the audio signal which are transmitted to the external device 120 of the user.

In some examples, the wearable device may be used to communicate with other wearable devices. The wearable devices may communicate directly, may communicate via connection to a common network, such as a cellular network or internet connection, or may communicate via connection to external devices. During communication between wearable devices, the wearable device or external device may determine the output words or phrases, from silent speech of the user, and generate an audio signal based on the output words or phrases, as discussed herein. This audio signal is transmitted to the other wearable devices where it is played over a speaker. The users of the other wearable devices may silently speak a response, from which the respective wearable device determines output words or phrases and an associated audio signal which is transmitted to and played on the speakers of the wearable device and other wearable devices.

A fourth function of the system may be to provide the user with information about their environment. The user may speak to ask for information about their environment, and the external device may perform natural language processing on the output words or phrases to determine one or more actions to be performed by the device. The external device may use data from sensors, separate from the sensors used in detecting user speech, in determining and performing the one or more actions. The one or more actions may include providing information about the environment to the user, which may include an identity of an object, an identity of a location, a direction, guidance instructions, information about an object, and information about a location.

FIG. 4F illustrates an example silent speech processing system which may be used by a user to receive information about their environment. In an example use case, the system may be used in conjunction with a navigation application of the external device. The user may silently speak a question to determine how they should navigate, which is recorded by the wearable device and sent to the external device as speech signals. The predicted speech module of the external device may identify the output phrase as “should I turn here?”, and the external device may process the output phrase using natural language processor 405 to determine an action to be performed.

The action may be to determine if the user should turn, and the action may require the external device to query a GPS sensor of the external device or the wearable device to determine a location of the user, which may be accomplished using application manager 406 and provided as application inputs 407. The navigation application of the external device 120 may compare this location to a location where the user is supposed to turn, and if the result of the comparison is above a threshold, the external device may provide a signal to the wearable device affirming the user should turn at that location. If the result of the comparison is below the threshold, the external device may provide a signal to the wearable device indicating the user should not turn there. The user may be played a sound or provided a visual signal to indicate whether they should or should not turn at their current location.

In another example use case, the system 110 may be used in conjunction with one or more sensors separate from the sensors used in detecting user speech, located on the external device 120 or wearable device 110. These sensors may include a camera positioned on the wearable device or the external device, which faces the environment of the user. The user may silently speak a question regarding their environment. The output phrase may be identified as “tell me about this monument,” using predicted speech module 122, as discussed herein, and the device may perform natural language processing on the output phrase to determine an action to be performed using natural language processor 405. The action may be to determine what monument the user is asking about and retrieve information about the monument. The action may require the external device to retrieve an image signal from a camera of the sensors 125 of external device 120 or the camera of the wearable device 110 and perform image processing on the image signal.

Application manager 406 may execute the action and provide image signals as application inputs 407. The image processing may include performing object recognition on the image signal received from the camera to determine the presence of one or more objects in the image signal. The object recognition may be performed using processors 127 located on the external device 120 or may be performed by sending the image signal to a cloud computing environment. The object recognition may be performed by using a machine learning-based computer vision model of models 121, maintained by the external device 120 to determine the object in the image signal. In some examples, the machine learning-based computer vision model may be maintained by a device other than external device 120 and is accessible by external device 120. The external device 120 may then query for information about the object. The information may be obtained from one or more sources accessed through an internet connection, such as websites or large language models. The information may be sent from the external device to the wearable device and the wearable device may provide the information to the user, such as by playing the information over a speaker of the wearable device.

FIG. 4G depicts a method 4000 which may be performed by the wearable device, external device, a connected device or any combination of devices to control one or more aspects of a device, for example as described with relation to FIGS. 4A and 4B. Method 4000 begins at S41, in which one or more digital signals associated with a user's speech are received. The digital signals may be generated as discussed with relation to FIGS. 2A and 2B.

In step S42, the digital signals are processed using one or more machine learning models to generate output words and phrases. The machine learning models may generate output words and phrases as discussed with relation to FIGS. 3A-C.

In step S43, natural language processing is performed on the signals to determine one or more actions which may be performed in response to the determined output words and phrases. The actions may be determined as discussed herein.

In step S44, the one or more actions are performed using one or more control modules, as discussed herein.

FIG. 4H depicts a method 4001 which may be performed by the wearable device, external device, a connected device or any combination of devices to control an application of an external device, for example as discussed with relation to FIGS. 4C and 4F. Method 4001 begins at step S411, in which one or more digital signals are received. The one or more digital signals may include digital signals associated with the user's speech recorded by the wearable device or external device, as discussed herein, or may include digital signals associated with the environment of the user.

In step S412 one or more machine learning models are used to determine one or more output words or phrases from the digital signals. The digital signals used to determine the one or more words or phrases in step S412 may include signals associated with the user's speech recorded by the wearable device or the external device, as discussed herein.

In step S413, natural language processing is performed on the one or more output words or phrases to determine one or more actions to be performed in response to the determined output words and phrases. The actions may be determined as discussed herein.

In step S414, an application of the external device may be configured to perform the one or more actions. Step S414 may involve starting or opening an application, or preparing an application for input, as discussed herein.

In step S415, an application of the external device may be provided inputs based on the one or more actions. The inputs may control the application to perform the one or more actions or may serve to control one or more aspects or features of the application as discussed herein. Step S415 may involve additional processing of digital signals such as signals associated with the environment of the user, as discussed herein.

FIG. 4H depicts a method 4002 which may be performed by the wearable device, external device, a connected device or any combination of devices to communicate with one or more other devices, for example as discussed with relation to FIGS. 4D and 4E. Method 4002 begins at S421, in which one or more digital signals associated with a user's speech are received. The digital signals may be generated as discussed with relation to FIGS. 2A and 2B.

In step S422, the digital signals are processed using one or more machine learning models to generate output words and phrases. The machine learning models may generate output words and phrases as discussed with relation to FIGS. 3A-C.

In step S423, the output words or phrases are used to generate an audio signal. The audio signal may contain sounds corresponding to speech of the one or more output words or phrases, as discussed herein. The audio signals are transmitted to one or more other devices in step S424. The audio signals may be transmitted using any suitable modality as discussed herein.

Now various embodiments of the wearable device and system will be discussed.

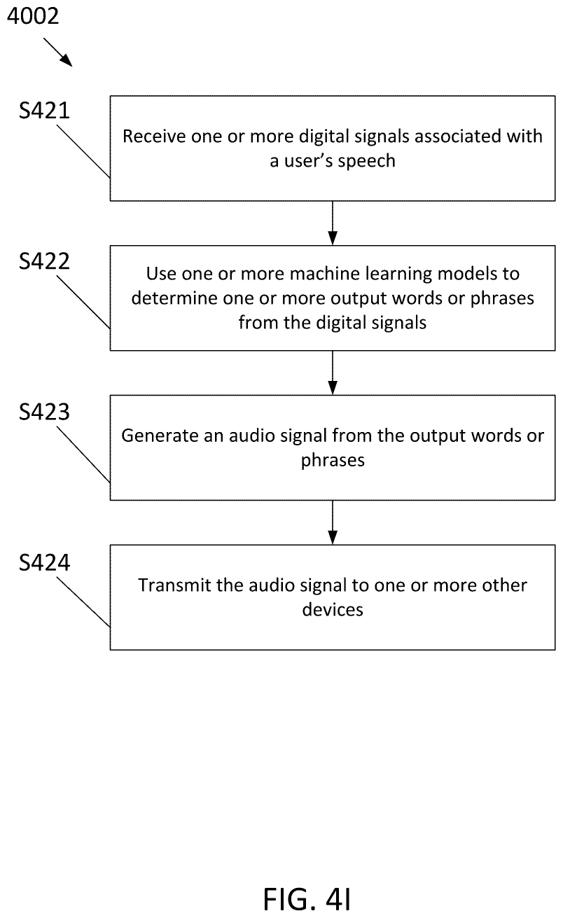

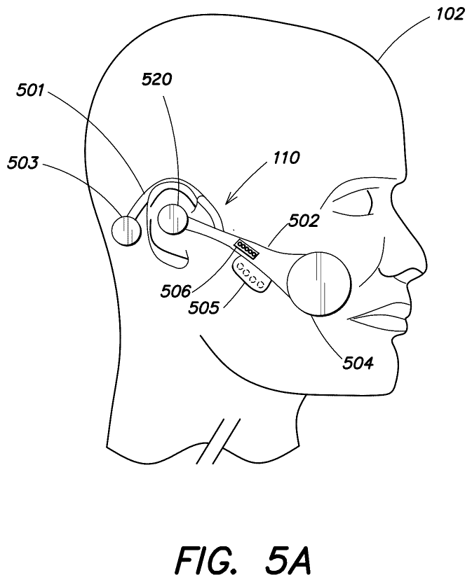

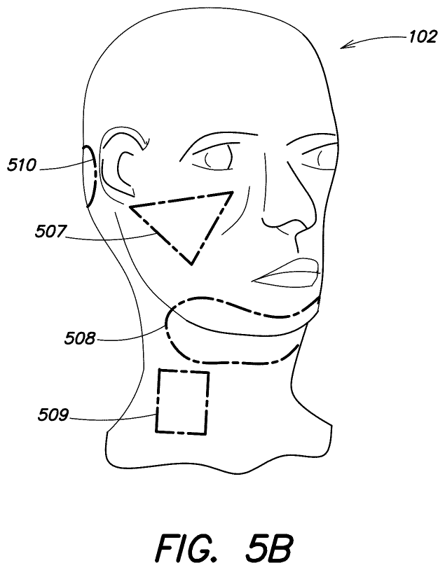

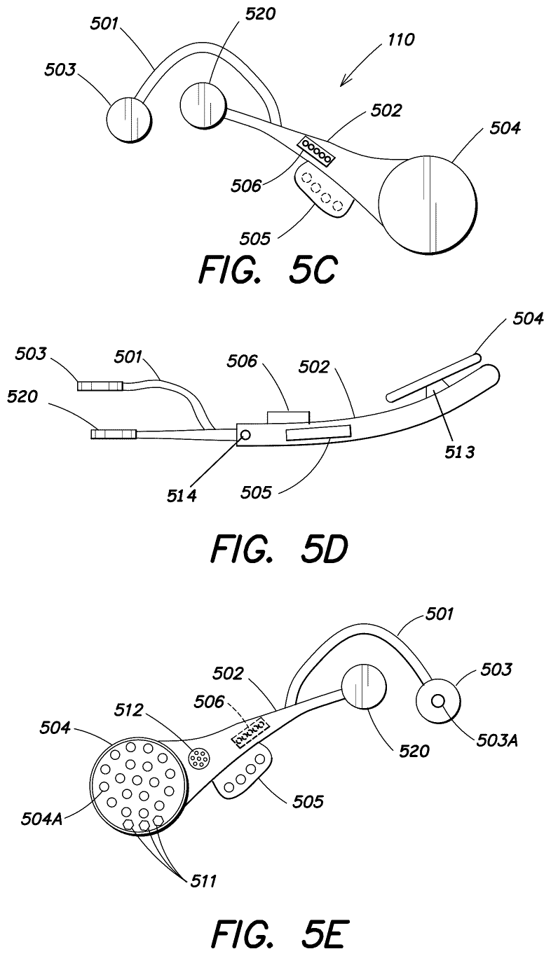

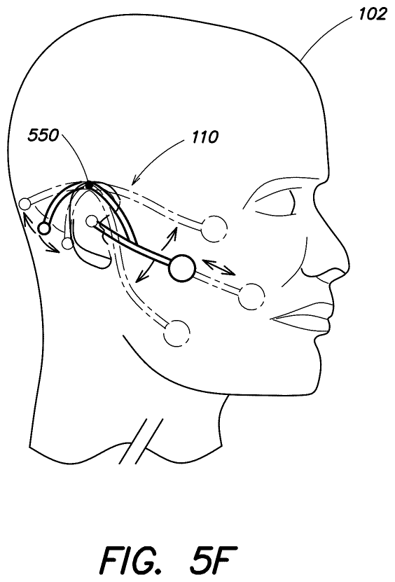

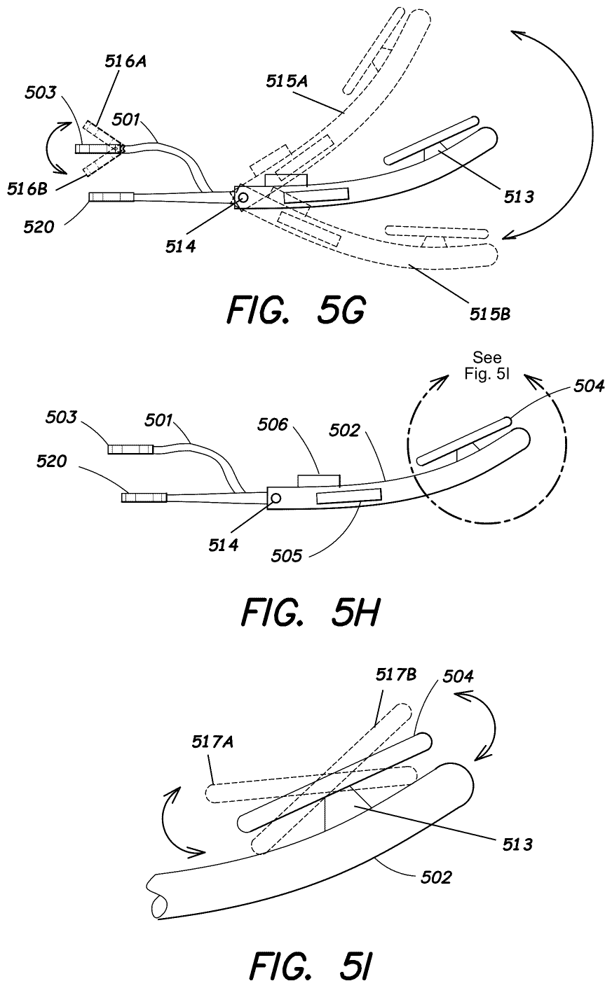

FIG. 5A depicts a view of a user 102 wearing an ear-hook embodiment of the wearable device 110, in accordance with some embodiments of the technology described herein. The wearable device may comprise an ear hook portion 501 configured to fit around the top of a user's ear. The ear hook 501 may support a sensor arm 502 of the wearable device 110 and a reference electrode 503 of the device. The ear hook may be adjustable to conform to the anatomy of a user. The wearable device 110 may additionally include one or more inputs 506, accessible to the user 102 while the wearable device 110 is being worn.

The wearable device may comprise a sensor arm 502, supported by the ear hook 501. The sensor arm 502 may contain one or more sensors for recording speech signals from the user 102. The one or more sensors supported by the sensor arm may include EMG electrodes 504 configured to detect EMG signals associated with speech of the user. The EMG electrodes may be configured as an electrode array or may be configured as one or more electrode arrays supported by the sensor arm 502 of the wearable device 110. In some examples, the EMG electrodes 504 may be dispensed over the sensor arm. The sensor arm 502 may be configured to provide a force to maintain contact between the face of the user and the EMG electrodes, which are located on a side of the sensor arm 502, facing the user 102.

In some examples, the EMG electrodes 504 may be supported on a rigid component. In some examples, the EMG electrodes 504 may be supported on a flexible component which can conform to a user's face during speaking and movement. In some examples, the EMG electrodes 504 may be arranged in a flat configuration. In some examples the EMG electrodes 504 may be arranged in a curved configuration.

In examples, where EMG electrodes 504 are configured as one or more electrode arrays, the one or more electrode arrays may have any suitable shape including circular, square, and rectangular. In some examples the electrode array may be a flat array in some examples the electrode array may be a curved array. In some examples, the electrode array may be rigid. In some examples, the electrode array is not rigid and can conform to the surface of the user's face during speaking and movement.

In some examples, the EMG electrodes 504 may be configured as a differential amplifier, wherein the electrical signals represent a difference between a first voltage measured by a first subset of electrodes of the plurality of electrodes and a second voltage measured by a second subset of electrodes of the plurality of electrodes. Circuitry for the differential amplifier may be contained within the wearable device 110. In some examples, the EMG electrodes may contain one or more inverting electrodes and one or more non-inverting electrodes. The electrical signals output by the amplifier may represent a difference between a voltage measured at a subset of inverting electrodes of EMG electrodes 504 and a subset of non-inverting electrodes of EMG electrodes 504. In some examples the inverting and non-inverting electrodes may be at a common location. In some examples, the inverting and non-inverting electrodes may be at separate locations. In some examples the EMG electrodes may be configured as multiple electrode arrays which contact the user at different locations, and each electrode array has one or more inverting and one or more non-inverting electrodes. In such examples all inverting electrodes may be connected or shorted together. In some examples, a control module of the wearable device may select an active inverting electrode or subset of inverting electrodes between two or more inverting electrodes or subsets of inverting electrodes. The control module may select the active inverting electrode based on the quality of contact between the inverting electrodes and the user. In some examples, the electrodes of EMG electrodes 504 are configured as inverting and non-inverting electrode pairs, and the non-inverting electrodes may measure the difference to the inverting electrodes. In some examples, inverting electrodes of the EMG electrodes 504 may be located separate from the non-inverting electrodes, for example inverting electrodes may be located adjacent reference electrode 503 at the mastoid of the user.

The sensor arm may support additional sensors 505. The additional sensors 505 may include a microphone for recording voiced or whispered speech, and an accelerometer or IMU for recording motion associated with speech. The additional sensors 505 may additionally include sensors configured to measure a position of a user's tongue, blood flow of the user, muscle strain of the user, muscle frequencies of the user, temperatures of the user, and magnetic fields of the user, among other signals. The additional sensors 505 may include photoplethysogram sensors, photodiodes, optical sensors, laser doppler imaging, mechanomyography sensors, sonomyography sensors, ultrasound sensors, infrared sensors, functional near-infrared spectroscopy (fNIRS) sensors, capacitive sensors, electroglottography sensors, electroencephalogram (EEG) sensors, and magnetoencephalography (MEG) sensors, among other sensors.

The ear hook 501 may additionally support one or more reference electrodes 503. The reference electrode 503 may be placed are located on a side of the ear hook 501, facing the user 102. In some examples reference electrode 503 may be configured to bias the body of the user such that the body is an optimal range for sensors of the system including sensors 505 and EMG electrodes 504. In some examples, the reference electrode 503 is configured to statically bias the body of the user. In some examples, the reference electrode 503 is configured to dynamically bias the body of the user. In some examples, the reference electrode 503 is configured to dynamically bias the body as a function of a common mode voltage as a function of measurements of non-inverting and inverting inputs. In some examples, the one or more reference electrodes 503 are configured to dynamically bias the body in a manner similar to a driven right leg (DRL) circuit.

In some examples, the one or more reference electrodes 503 may be configured as separate reference electrode arrays in separate locations and used in conjunction in a driven right leg electrode arrangement, in which electrical signals from the user's body are measured at first and second locations and a voltage is applied to the user's body at a third location. An example of this arrangement may be seen in FIG. 5E with additional reference electrodes 511. The voltage applied at the third location is a voltage opposite a common voltage measured at the first and second locations. This voltage can be a function of the common mode voltage measured at the first and second locations. This technique will destructively interfere with electrical signals common to the body of the user and will amplify electrical signals at a particular portion of the user, for example the user's face.

In some examples, the EMG electrodes 504 may be configured as separate arrays and used in a driven right leg electrode arrangement. In this arrangement, separate arrays of EMG electrodes 504 may measure the electrical signals from the user's body and the reference electrode 503 may apply a voltage to the user's body. The voltage applied at the third location is a voltage opposite a common voltage measured at the first and second locations. This voltage can be a function of the common mode voltage measured at the first and second locations. This technique will destructively interfere with electrical signals common to the body of the user and will amplify electrical signals at a particular portion of the user, for example the user's face.

The wearable device 110 may include a speaker 520 positioned at an end of the sensor arm. The speaker 520 is positioned at the end of the sensor arm 502 closest the user's ear. The speaker 520 may be inserted into the user's ear to play sounds, may perform bone conducting to play sounds to the user, or may play sounds aloud adjacent to the user's ear. The speaker 520 may be used to play outputs of silent speech processing or communication signals as discussed herein. In addition, the speaker 520 may be used to play one or more outputs from a connected external device, or the wearable device, such as music, audio associated with video or other audio output signals.

The wearable device 110 may include other components which are not pictured. These components may include a battery, a charging port, a data transfer port, among other components.

The wearable device 110 may be configured to contact the face and neck of the user in multiple target zones for EMG electrode and other sensor placement. FIG. 5B illustrates a view of a user with target zones marked on the face and neck of the user. A first target zone 507 may be on the cheek of the user. This first target zone 507 may be used to record electrical signals associated with muscles in the face and lips of the user, including the zygomaticus of the user, the masseter of the user, the buccinator of the user, the risorius of the user, the platysma of the user, the orbicularis oris of the user, the depressor anguli oris of the user, the depressor labii, the mentalis, and the depressor septi of the user. The electrodes supported by the sensor arm of the wearable device of FIG. 5A may contact the first target zone 507 of the user. Sensors configured to measure the position and activity of the user's tongue may be supported at the first target zone 507 by the sensor arm. Accelerometers configured to measure movement of the user's face may be placed at the first target zone 507.

A second target zone 508 is shown along and under the jawline of the user. The second target zone 508 may include portions of the user's face above and under the chin of the user. The second target zone 508 may include portions of the user's face under the jawline of the user. The second target zone 508 may be used to measure electrical signals associated with muscles in the face, lips jaw and neck of the user, including the depressor labii inferioris of the user, the depressor anguli oris of the user, the mentalis of the user, the orbicularis oris of the user, the depressor septi of the user, the mentalis of the user, the platysma of the user and the risorius of the user, at electrodes supported by the wearable device. Additional sensors may be supported by the wearable device at the second target zone 508 including accelerometers to measure the movement of the user's jaw and sensors configured to detect the position and activity of the user's tongue.

A third target zone 509 is shown at the neck of the user. The third target zone 509 may be used to measure electrical signals associated with muscles in the neck of the user the sternal head of sternocleidomastoid of the user, and the clavicular head of sternocleidomastoid Accelerometers may be supported at the third target zone to measure vibrations and movement generated by the user's glottis during speech, as well as other vibrations and motion at the neck of user 102 produced during speech.

A reference zone 510 may be located behind the ear of the user at the mastoid of the user. Reference electrodes may be placed at the reference zone 510 to supply a reference voltage to the face of the user, as discussed herein. Reference zone 510 may also include portions of the user's head behind and above the ear of the user.

FIGS. 5C-5E illustrate different views of the wearable device, according to embodiments of the technology described herein. Shown in FIG. 5C is a front view of an ear hook embodiment of wearable device 110. The wearable device 110 may include a reference electrode 503, ear hook 501, sensor arm 502, sensors 505, and EMG electrodes 504. The wearable device 110 may also include one or more input sensors 506 which are used to control the device 110. The input sensors may be configured as buttons 506 as shown in FIG. 5C, or in some examples may be configured as capacitive sensors. The input sensors 506 may be connected to a control module of the wearable device 110 and may provide signals to the control module of the device 110 to control one or more aspects or functions of the device 110. Signals provided by the input sensors 506 may turn on or off the wearable device 110, start and stop recording functions of the wearable device 110, answer or accept a call to the device 110 or a paired external device, control a volume of a speaker of the device 110, control a volume of a speaker of a paired external device, control a mode of the wearable device 110, and to control pairing of the wearable device 110 with an external device, among other controllable functions.

FIG. 5D illustrates a bottom view of the wearable device. As discussed, the wearable device may be configured to maintain contact between the sensors and the wearer's face. For example, the sensor arm 502 may be shaped with a curve such that the EMG electrodes 504 and sensors 505 maintain contact with the user's face. In some examples, the sensor arm may be configured to maintain contact with the user's face via a compliant mechanism 514. The compliant mechanism 514 may be sprung by a spring as discussed herein. Any suitable compliant mechanism 514 may be used including a hinge as discussed, flexible materials, and materials structured to have flexible properties. In some examples, compliant mechanism 514 may be configured as a portion of the sensor arm 502 which is made of a flexible material and is configured to deflect against the user's face in order to maintain contact.

As shown in FIG. 5D, the compliant mechanism 514 is configured as a hinge. The sensor arm 502 may be coupled to the ear hook 501 via hinge 514 and a spring may act on the hinge to maintain contact between the sensor arm 502 and the user's face. The hinge 514 may be sprung by any suitable spring including a coil spring, a leaf spring, a torsion spring, a disk spring, a wave spring, a rubber spring, a rubber gasket and a flat spring, among other suitable springs.

The EMG electrodes 504 may be coupled to the sensor arm 502 via a movable connection 513. The movable connection may allow the EMG electrodes to maintain constant contact with the face of the user, independent of movement of the sensor arm 502. The movable connection 513 may include but is not limited to a ball-in-socket connection, a universal joint, a u-joint, a hinge, a rubber spring, a flexure, an elastic joint, a hinge, and any other suitable connection. The movable connection 513 may be sprung to return to a set position with a desired returning force. The movable connection 513 may be sprung by a rubber spring and provides the returning force based on the material properties of the rubber spring and may have an elastic material molded over the movable connection 513. In some examples, the movable connection may be sprung by springs including a coil spring, a leaf spring, a torsion spring, a disk spring, a wave spring, and a flat spring, among other suitable springs. The movable connection 513 may be sprung in a single direction or may be sprung in multiple directions. In some examples, movable connection 513 may be configured to be fixed in a selected position. In some examples, one or more degrees of freedom of movable connection 513 may be fixed or locked.

FIG. 5E illustrates an inside view of the wearable device. Visible in FIG. 5E is the reference electrode 503, sensors 505, EMG electrodes 504, microphone 512, ear hook 501 and sensor arm 502. The reference electrode 503 may be supported by the ear hook 501 to contact the user behind the ear of the user at the reference zone as discussed with respect to FIG. 5B. Shown in FIG. 5E is a single reference electrode 503A, however one or more reference electrodes 503 may be used to provide a reference voltage, as discussed herein.

In some examples, EMG electrodes 504 may have respective reference electrodes 511 positioned adjacent to the EMG electrodes 504, as shown in FIG. 5E. EMG electrodes 504 may include any suitable number of electrodes such as electrode 504A. In some examples, a subset of electrodes 504 may be used to record signals from the user's face, while the remaining electrodes are not used to record signals from the user's face. The subset of electrodes may be selected by the wearable device using one or more factors including the positioning of the electrodes, the signal strength from the electrodes, the signal quality from the electrodes, among other factors. In some examples, the electrodes may be configured as polar electrodes. The electrodes 504, 511 and 503 may be domed electrodes, and may be made from gold-plated brass, silicon and/or silver. In some examples, the electrodes 504, 511 and 503 may be silicon electrodes. The electrodes may be configured to operate at any suitable frequency, for example at frequencies less than 1000 Hz.

In some examples the wearable device may utilize both reference electrode locations at the mastoid of the user, corresponding to reference electrode 503 and at the EMG electrodes 504, corresponding to the cheek, face and/or other portion of the user. In some examples the wearable device may utilize a single reference electrode location. In some examples, the wearable device may toggle between two or more reference electrode locations. The wearable device may select a reference electrode location based on a level of contact being greater at a location. In some examples, the wearable device may electrically connect two or more electrode locations together to provide a common voltage to the user.

Microphone 512 may be used to record voiced speech from the user. Voiced speech may be used in the training of machine learning models used to determine output words or phrases from the speech signals recorded by the wearable device. Training may be performed by comparing one or more words or phrases identified from voiced speech recorded by microphone 512 to one or more words or phrases determined from speech signals recorded at other sensors, simultaneously with the voiced speech. Microphone 512 may also be used to record and transmit voiced speech signals from the user. In some examples, the wearable device 110 may contain one or more additional microphones. The wearable device may process signals from microphone 512 and the one or more additional microphones using processors and processing components as described herein. In some examples, signals from the microphones may be processed to perform beamforming on the signals such that audio signals from a location corresponding to the user's mouth are amplified.

The sensors 505 are also visible in the inside view of the wearable device. Although four sensors 505 are shown in FIG. 5E, any suitable number of sensors 505 may be included, as discussed herein.

FIG. 5F illustrates adjustability of the ear hook embodiment of the wearable device 110, according to embodiments of the technology described herein. The wearable device 110 may be adjusted to conform to the anatomy of the user, to improve sensor placement for signal recording, and/or to improve comfort, among other reasons. The wearable device 110 may incorporate one or more adjustment mechanisms. For example, the wearable device may be made of a flexible, conformal material, which can be adjusted to a particular shape. This may be done to achieve desired placement of the ear hook or sensor arm. The sensor arm may additionally be configured for length adjustments. This may be accomplished though telescoping segments of the sensor arm or through folding segments of the sensor arm. The sensor arm may be rotatably positioned about anchor point 550, where the ear hook contacts the ear of the wearer. The sensor arm may be linearly positioned closer and farther from the user's mouth. The sensor arm may be positioned closer and farther from the user's check. In some examples the sensor arm may engage with a spring to maintain contact with the user's face.

FIG. 5G illustrates motion of components of the wearable device 110. As discussed herein, sensor arm 502 may be coupled to the ear hook via a compliant mechanism 514 configured as a hinge as shown. The dashed outlines of the sensor arm, 515A and 515B, illustrate an exemplary range of motion for the sensor arm about the compliant mechanism 514. The sensor arm 502 may move about compliant mechanism 514 in order to maintain contact between the sensors 505, EMG electrodes 504 and the face of the user.

The ear hook 501 may additionally be configured to move in order to support the wearable device at the ear of the user. The ear hook 501 may have a hinge or flexible portion integrated within, which allows a movable rear portion of the ear hook to move, as shown in FIG. 5G. Dashed outlines 516A and 516B illustrate an exemplary range of motion for the movable rear portion of the ear hook about a hinge or flexible portion. The movable rear portion of the ear hook may be sprung to provide a clamping force between the wearable device 110 and the ear of the user to support the wearable device at the user's ear. Any suitable spring may be used to provide the clamping force at the ear hook 501, including a coil spring, a leaf spring, a torsion spring, a disk spring, a wave spring, a rubber spring, and a flat spring, among other suitable springs.

FIG. 5I is a detailed view of FIG. 5H, showing the EMG electrodes 504 of the wearable device 110. As discussed herein, EMG electrodes 504 may be coupled to the sensor arm 502 by a movable connection 513. The movable connection 513 may allow for movement of the EMG electrodes 504 in order to maintain contact with the user's face. The EMG electrodes 504 may have a range of motion illustrated by the dashed outlines 517A and 517B. The EMG electrodes may additionally be configured to rotate in other directions including in directions normal to those shown in FIG. 5I and may be configured to rotate about movable connection 513 such that the EMG electrodes have three degrees of freedom with respect to the sensor arm 502. In some examples the EMG electrodes 504 may have one or two degrees of freedom with respect to the sensor arm 502, and in other examples the EMG electrodes 504 may have greater than three degrees of with respect to the sensor arm 502. In some examples, one or more degrees of freedom of the EMG electrodes with respect to the sensor arm may be fixed or locked by the user.

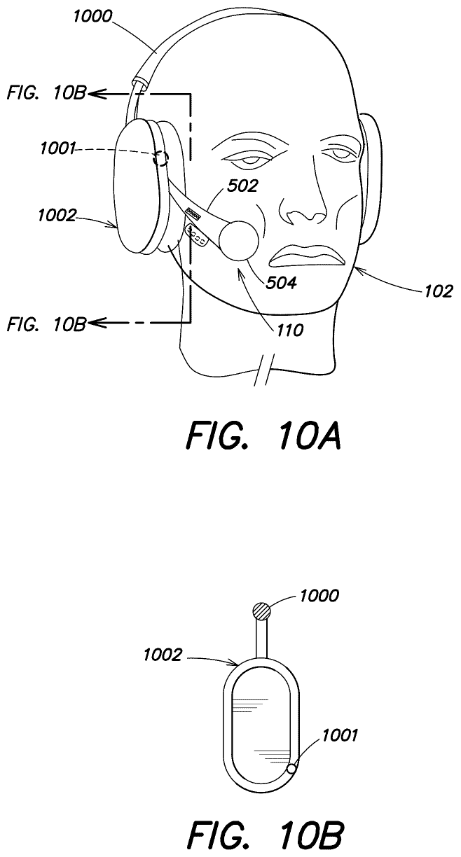

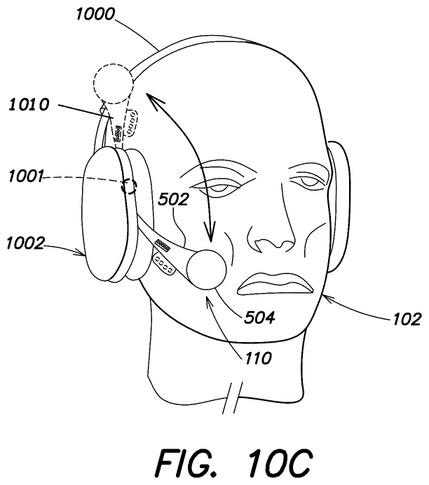

In some examples, the sensor arm may move about its connection to the ear hook to a stowed position. The sensor arm may be configured to rotate or fold into the stowed position. In the stowed position, the sensor arm is positioned at a side of the users head, at, above or behind the ear of the user, and away from the face of the user. This action of moving the sensor arm to a stowed position may be similar to that as described in relation to FIG. 10C.

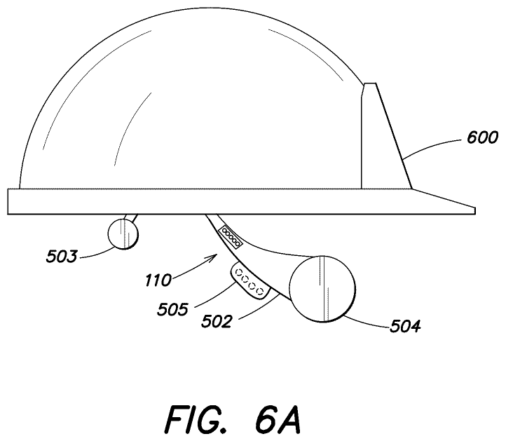

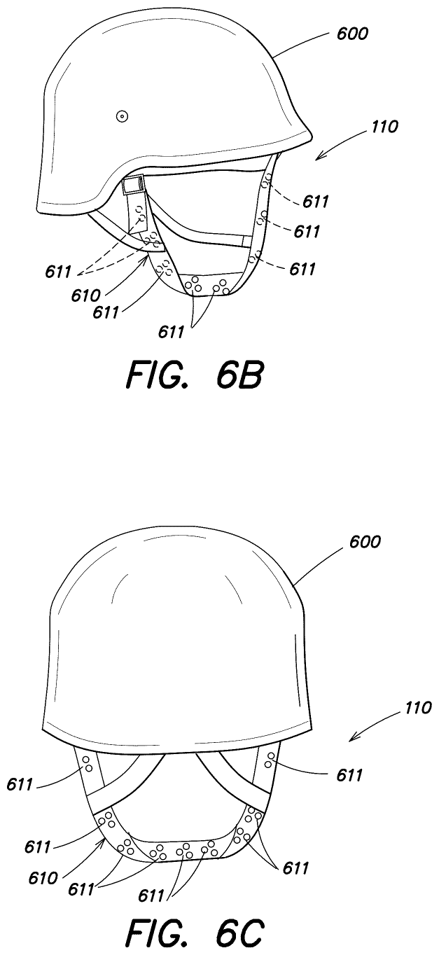

FIG. 6A illustrates an embodiment of the wearable device where the components of the wearable device 110 are contained within a helmet 600. The helmet 600 may support a sensor arm 502 and reference electrode 503 to contact the face of the user at the mastoid of the user, which may operate as discussed herein. The helmet may be used in applications where users need to verbally communicate in environments where verbal communication is difficult to achieve or may not be a desirable form of communication. Such applications may include construction, law enforcement, and sporting events, among other applications.

FIG. 6B illustrates an embodiment of the wearable device where the components of the wearable device 110 are integrated within the chin strap 610 of a helmet 600. The chin strap 610 may be tightened to maintain contact between the sensors of the wearable device 110 and the user's face.

FIG. 6C illustrates a rear view of the embodiment of the wearable device where the components of the wearable device 110 are integrated within the chin strap 610 of the helmet 600. As shown, multiple sets of sensors 611 may be included along the chin strap 610 of the helmet 600. The sensors 611 may include any suitable sensors as discussed herein for detecting silent and voiced speech, including but not limited to: EMG electrodes for recording of muscle activity associated with speech, a microphone for recording voiced or whispered speech, an accelerometer or IMU for recording motion associated with speech and other sensors for recording signals associated with silent and voiced speech as discussed herein.

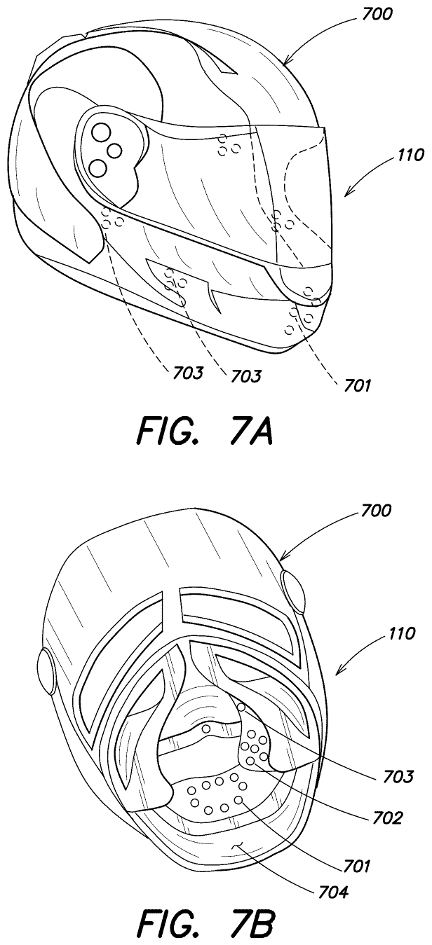

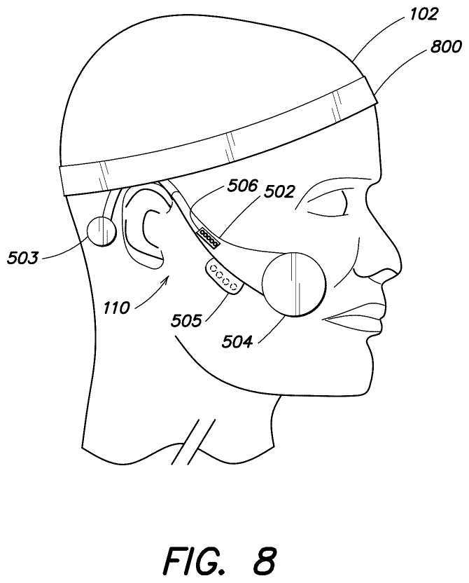

FIG. 7A illustrates an embodiment of the wearable device 110, where the components of the wearable device are integrated within a full-face helmet 700, such as a motorsports helmet, a football helmet, a lacrosse helmet, and a snowsports helmet, among other helmets with full face or jaw coverage. The full-face helmet may support sensors without a sensor arm. The full-face helmet may support any sensors as described herein.

FIG. 7B illustrates placement of the components of the wearable device within helmet 700. Visible in FIG. 7B is EMG electrodes 701 which contacts target zone 2 of the user's face, EMG electrodes 702 which contacts target zone 1 of the user's face and a reference electrode 703 which contacts the user behind an ear of the user, the reference electrode 703 may operate as discussed herein. EMG electrodes 701 may be supported by a mask portion of helmet 700, and the mask portion of the helmet may be used to support additional sensors.

FIG. 8 illustrates an embodiment of the wearable device 110, wherein the components of the wearable device 110 are supported by a strap 800. The strap may support a sensor arm 502 and reference electrode 503 to contact the face of the user at the mastoid of the user, which may operate as discussed herein.

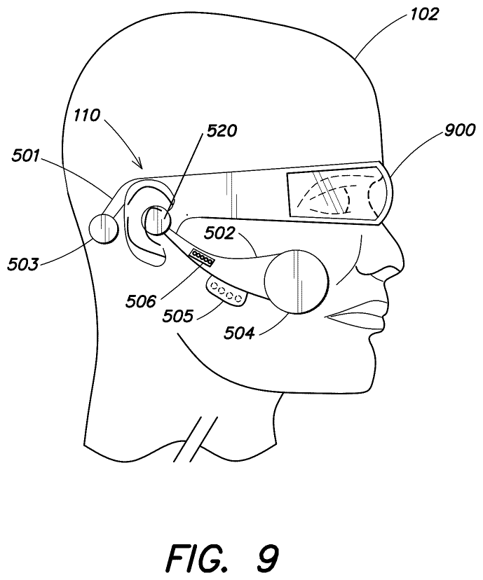

FIG. 9 illustrates an embodiment of the wearable device, wherein the components of the wearable device are supported by glasses 900. The glasses may support a sensor arm 502 and reference electrode 503 to contact the face of the user at the mastoid of the user, as discussed herein. In some examples, the glasses 900 may be smart glasses and the speech signals recorded by the wearable device may be used to control applications or a display of the smart glasses 900, as discussed herein with the control of external devices.

FIG. 10A illustrates an embodiment of the wearable device 110, wherein the components of the wearable device are integrated within headphones 1000. The headphones 1000 may support a sensor arm 502, as discussed herein, and reference electrode 1001 to contact the face of the user at the mastoid of the user, the reference electrode may operate as discussed herein.

The reference electrode 1001 may be integrated within a speaker cup 1002 of the headphones as shown in FIG. 10B.

FIG. 10C illustrates movement of the sensor arm 502 between a deployed and stowed position. The stowed position is shown by dashed outline 1010. The sensor arm 502 may be stowed to not interfere with the user's face and or for comfort when not in use. The sensor arm may be connected to headphones at a pivot which allows movement between the deployed and stowed position. In some examples, one or more functions of the wearable device may be disabled when the sensor arm 502 is moved to the stowed position.

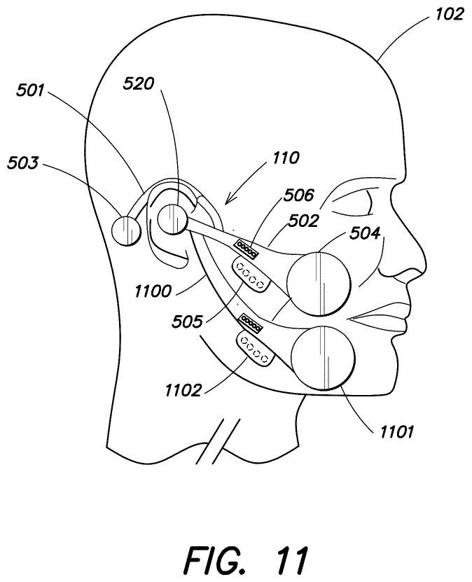

FIG. 11 illustrates an embodiment of the wearable device 110, wherein the wearable device 110 includes a second sensor arm 1100. The second sensor arm 1100 may be configured to contact target zone two of the user 102, at or underneath the jawline of the user 102. The second sensor arm 1100 may include multiple sensors including EMG electrodes 1101, and other sensors 1102 as discussed herein. Recorded speech signals from the first sensor arm 502 and the second sensor arm 1100 may be processed as discussed herein.

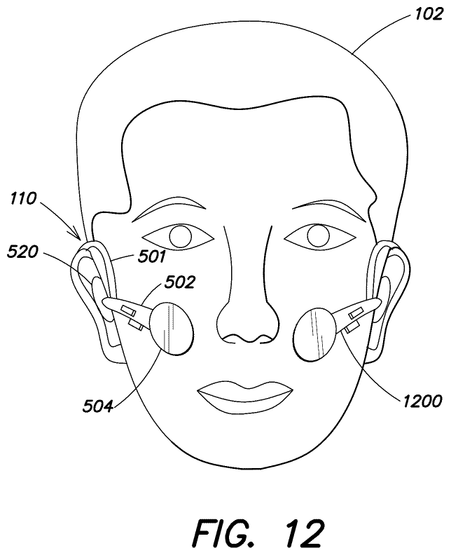

FIG. 12 illustrates an embodiment of the wearable device 110 wherein the wearable device 110 contains two sensor arms 502 and 1200. In FIG. 12, the two sensor arms 502 and 1200 are configured to contact the first target zones on the right and left sides of the user's face. The two sensor arms may be configured to contact any other sensor zones as discussed herein. The two sensor arms 502 and 1200 may support multiple sensors as discussed herein. Sensor arm 502 may be configured to contact the right side of a user's face, and sensor arm 1200 may have sensors positioned on the opposite side of the arm such that the sensors contact the left side of the user's face. In some examples, the wearable device may support two reference electrodes, one on the right side of the user's face and one on the left side of the user's face. The reference electrodes may be supported behind the user's cars and may operate as discussed herein.

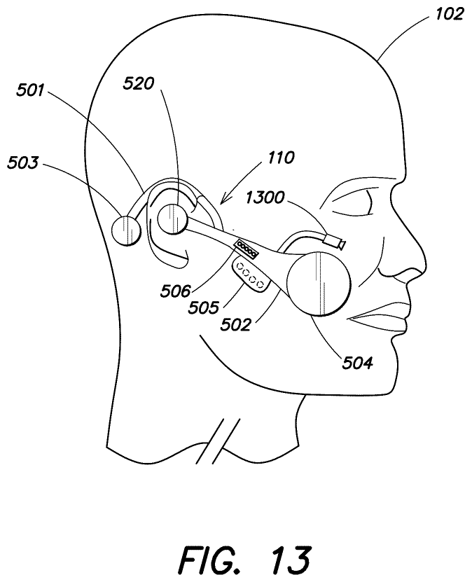

FIG. 13 illustrates an embodiment of the wearable device 110 where the wearable device 110 supports one or more cameras. The one or more cameras may include a first camera 1300 directed towards the face of the user. The camera 1300 may be supported by a sensor arm 502. The camera 1300 directed towards the face of the user may be used to record video of the mouth of the user. The video of the mouth of the user may be used in determining the one or more output words or phrases from the speech signals recorded by the wearable device. A computer vision machine learning model may be trained to determine words or phrases from videos of a user speaking. This computer vision machine learning model may be maintained on the wearable device 110, a connected external device or on a cloud computer server accessible by the wearable device 110 or the connected external device. The video signals recorded from the camera 1300 directed towards the face of the user may be processed with other speech signals as discussed herein. The wearable device 110 may also support a camera directed towards the environment of the user 102. Video signals of the environment of the user may be processed as discussed herein.

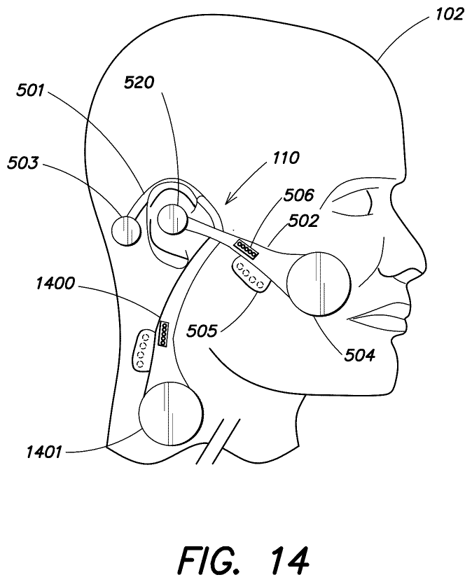

FIG. 14 illustrates an embodiment of an ear hook embodiment of the wearable device 110 where the wearable device supports a second sensor arm 1400 which contacts the user at the third target zone as discussed herein. The second sensor arm 1400 may support one or more sensors as discussed herein. The second sensor arm 1400 may support EMG electrodes 1401 which measure electrical signals associated with muscles in the neck of the user, including the sternal head of sternocleidomastoid of the user, and the clavicular head of sternocleidomastoid. The second sensor arm 1400 may also support accelerometers to measure vibrations and movement generated by the user's glottis during speech. The second sensor arm 1400 may be adjustable to conform to patient anatomy as discussed herein.

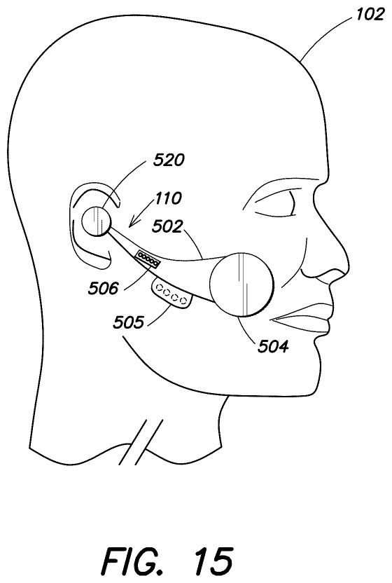

FIG. 15 illustrates an embodiment of the of the wearable device, where the wearable device 110 is supported by a speaker 520. The speaker 520 may be inserted into the ear of the user as shown in FIG. 15. The speaker may include one or more features to maintain a secure connection between the speaker and the user's ear in order to support the wearable device 110 from the user's ear. The speaker 520 may be used to play outputs of silent speech processing or communication signals as discussed herein. In addition, the speaker 520 may be used to play one or more outputs from a connected external device, or the wearable device, such as music, audio associated with video or other audio output signals.

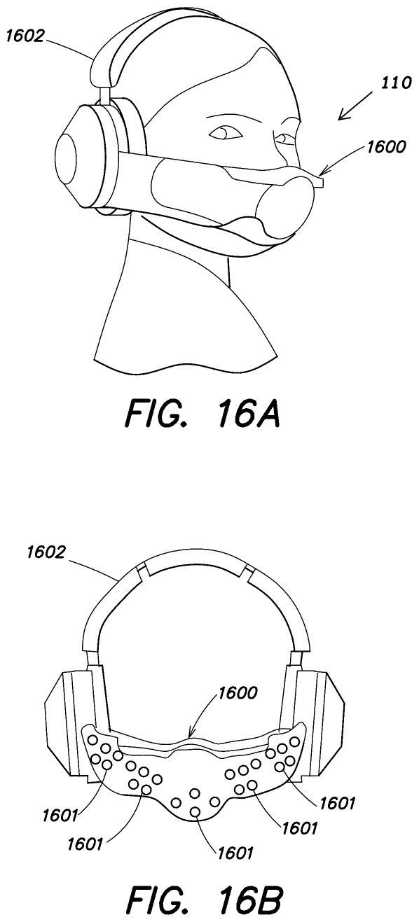

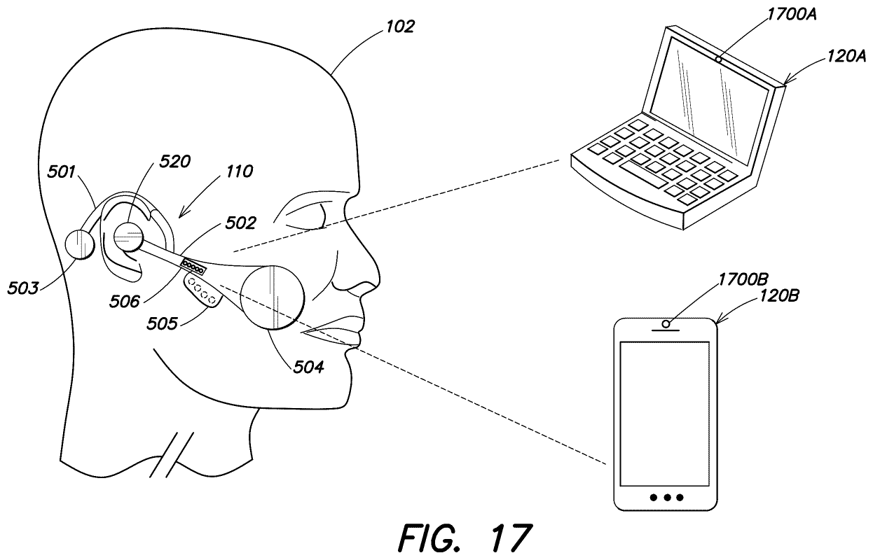

FIG. 16A illustrates an embodiment of the wearable device where the components of the wearable device are integrated within a smart mask 1600. The smart mask 1600 may be attached to headphones 1602 which may be used to play audio as discussed herein.

FIG. 16B illustrates a rear view of the embodiment of the wearable device where the components of the wearable device 110 are integrated within a smart mask 1600. As shown, multiple sets of sensors 1601 may be included within the smart mask 1600. The sensors 1600 may include any suitable sensors as discussed herein for detecting silent and voiced speech, including but not limited to: EMG electrodes for recording of muscle activity associated with speech, a microphone for recording voiced or whispered speech, an accelerometer or IMU for recording motion associated with speech and other sensors for recording signals associated with silent and voiced speech as discussed herein.

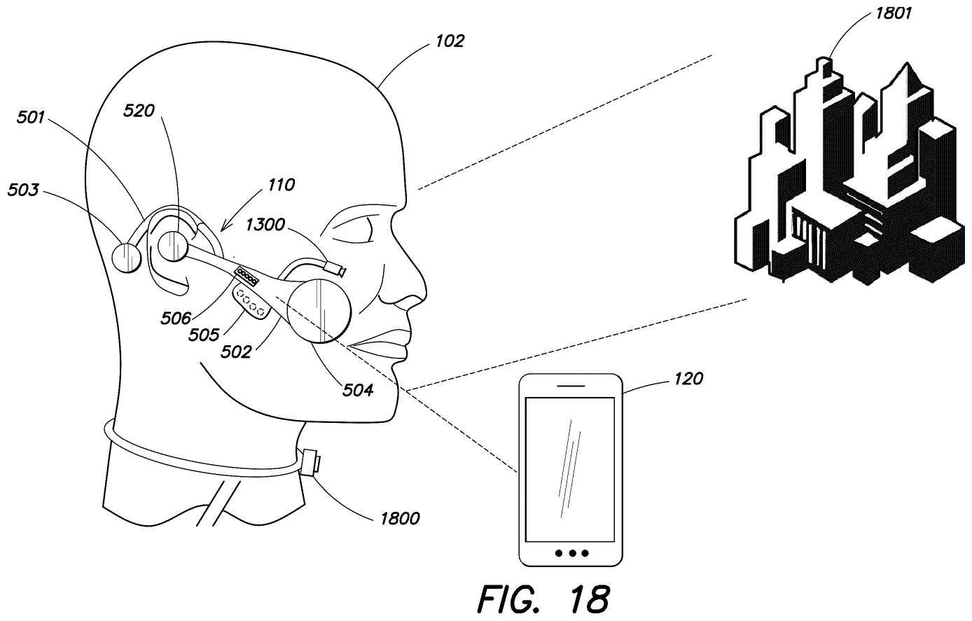

FIG. 17 illustrates a system in which a wearable device is used to control a connected external device, according to aspects of the present invention. The external devices as shown in FIG. 17 includes a laptop 120A, and a cellular phone 120B, however, any suitable device may be used including a tablet, a desktop computer, a projector, a television, a multimedia system and smart glasses, among other devices.

The wearable device 110 may record silent and voiced speech signals of the user and these signals may be used to control one or more aspects of the connected external device 120A or 120B. The signals may be used to control a user interface of the connected external device 120, to control an application of the device, to provide an input to the device, to retrieve information from the device or to access or control one or more additional functions of the device, as discussed herein.

In some examples, the external device 120A or 120B may comprise a camera facing the user 1700A and 1700B respectively. The camera 1700A or 1700B facing the user 102 may be a front facing camera of the device, may be a webcam connected to the device, or may be any other camera connected to or integrated within the device. The camera 1700A or 1700B may be used to record video signals of the user's face which may be processed with speech signals recorded by the wearable device to determine the output words or phrases, as discussed herein.

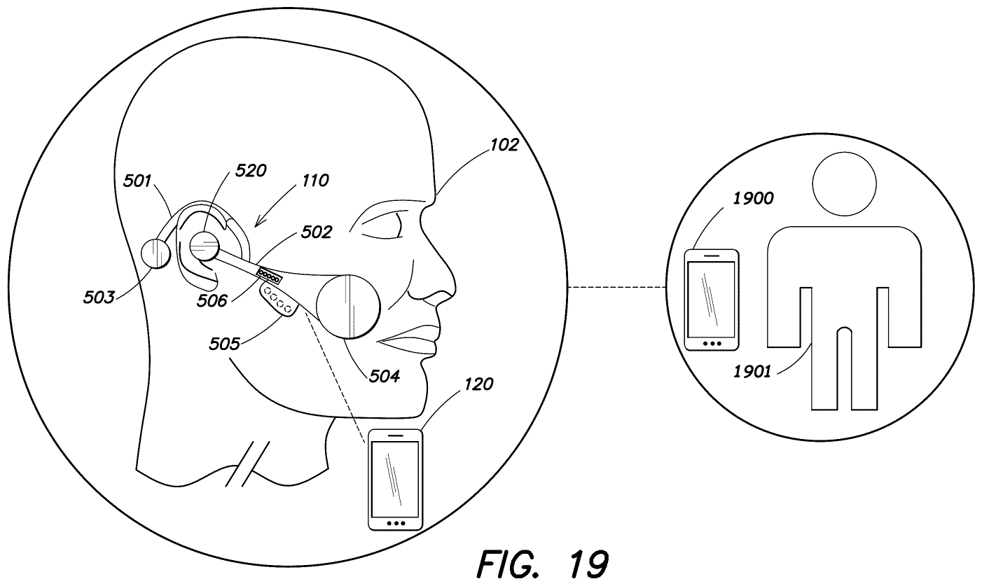

FIG. 18 illustrates a system in which a wearable device 110 may be used in conjunction with an external device to obtain information about the environment 1800 of the user. As shown in FIG. 18, the external device may be a mobile device with a camera such as a cellphone or may be an additional wearable device worn by the user 102 such as a necklace 1800, however any suitable external device may be used. In some examples the wearable device may comprise a camera 1300 configured to record video signals of the environment 1801, as discussed herein. The camera of the wearable device 110, external device 120 or other connected device 1800, may record a video signal which may be analyzed to provide information to the user 102 about the environment 1801, as described herein. In some examples, the user 102 may direct the camera towards a particular portion of the environment 1801 which they desire information about and may silently speak a request for information on the portion of the environment.

FIG. 19 illustrates an example of a system in which a wearable device 110 is used for communication with one or more individuals. As shown in FIG. 19, the user 102 may silently speak, from which signals are recorded by the wearable device 110. Output words and phrases may be determined from these signals by the wearable device 110 or a connected external device 120 and converted to an audio signal by the wearable device 110 or a connected external device 120, as discussed herein. The wearable device 110 may communicate the audio signal directly to the device 1900 of the receiving individual 1901. The receiving device 1900 may be any suitable device such as a cellular phone, a telephone, a computer, a wearable device as discussed herein, among other devices. The individual 1901 using the receiving device 1900 may respond to the user. The wearable device 110 of the user may play the response from the individual using one or more speakers 1500 of the wearable device.

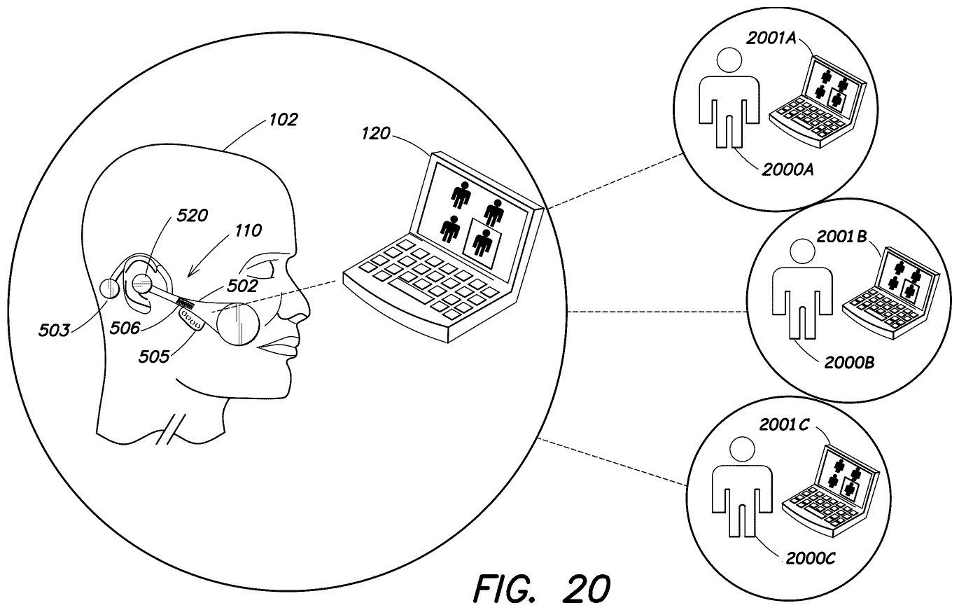

FIG. 20 illustrates an example of a system in which a wearable device is used for video conferencing with one or more individuals 2000A, 2000B and 2000C. As shown in FIG. 20, the user 102 may silently speak, from which signals are recorded by the wearable device 110. Output words and phrases may be determined from these signals by the wearable device or a connected external device 120 and converted to an audio signal by the wearable device 110 or a connected external device 120, as discussed herein. The connected external device 120 may record video of the user. In some examples the video of the user recorded by the connected external device 120 may be used with the speech signals recorded by the wearable device 110, in determining the one or more output words or phrases, as discussed herein. The video recorded by the connected external device 120 may be sent to the receiving devices 2001A, 2001B and 2001C of the respective individuals video conferencing with the user. The connected external device 120 may perform one or more operations to align the audio signal with the video recorded by the connected external device 120 to ensure the sounds of the audio signal are played at the same time as the user is speaking 102 the words in the video.

Having thus described several aspects of at least one embodiment of the technology described herein, it is to be appreciated that various alterations, modifications, and improvements will readily occur to those skilled in the art. Such alterations, modifications, and improvements are intended to be part of this disclosure and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. A computer-readable storage medium includes any computer memory configured to store software, for example, the memory of any computing device such as a smart phone, a laptop, a desktop, a rack-mounted computer, or a server (e.g., a server storing software distributed by downloading over a network, such as an app store)). As used herein, the term “computer-readable storage medium” encompasses only a non-transitory computer-readable medium that can be considered to be a manufacture (i.e., article of manufacture) or a machine. Alternatively, or additionally, aspects of the technology described herein may be embodied as a computer readable medium other than a computer-readable storage medium, such as a propagating signal.

The terms “program” or “software” are used herein in a generic sense to refer to any type of computer code or set of processor-executable instructions that can be employed to program a computer or other processor to implement various aspects of the technology as described above. Additionally, it should be appreciated that according to one aspect of this embodiment, one or more computer programs that when executed perform methods of the technology described herein need not reside on a single computer or processor but may be distributed in a modular fashion among a number of different computers or processors to implement various aspects of the technology described herein.

Computer-executable instructions may be in many forms, such as program modules, executed by one or more computers or other devices. Generally, program modules include routines, programs, objects, modules, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIGS. 2B, 4G, 4H and 4I. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B.” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising.” “including.” “carrying.” “having,” “containing,” “involving.” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately” and “about” may be used to mean within +20% of a target value in some embodiments, within +10% of a target value in some embodiments, within +5% of a target value in some embodiments, within +2% of a target value in some embodiments. The terms “approximately” and “about” may include the target value.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A wearable device, comprising:
a plurality of electrodes, wherein a subset of the plurality of electrodes are configured to measure electrical signals at a face, head, or neck of a user, the electrical signals being indicative of the user's speech activation patterns while the user is silently speaking or whispering;
a processing module configured to receive the electrical signals from the plurality of electrodes and perform one or more processing operations of the electrical signals; and
a communication module communicatively coupled to an external device.

2. The wearable device of claim 1, wherein the plurality of electrodes is supported to contact the user's face by a sensor arm, the sensor arm being supported at a side of the user's head.

3. The wearable device of claim 2, wherein the sensor arm is coupled to an ear hook, the ear hook configured to support the wearable device at an ear of the user.

4. The wearable device of claim 2, wherein the sensor arm is coupled to a headset, the headset configured to support the sensor arm at a side of the head of the user.

5. The wearable device of claim 2, wherein the sensor arm is coupled to a temple of glasses or goggles.

6. The wearable device of claim 2, wherein the sensor arm is configured to be rotatably positioned about an anchor point, and wherein the sensor arm is configured to be linearly positioned closer and farther from the user's mouth.

7. The wearable device of claim 2, further comprising a spring configured to maintain contact between the sensor arm and the user's cheek.

8. The wearable device of claim 1, further comprising a reference electrode supported to contact the body of the user above or behind an ear of the user and provide a bias voltage to the body of the user.

9. The wearable device of claim 8, wherein the plurality of electrodes electrode is configured as a differential amplifier, wherein the electrical signals represent a difference between a first voltage measured by a first subset of electrodes of the plurality of electrodes and a second voltage measured by a second subset of electrodes of the plurality of electrodes.

10. The wearable device of claim 1, wherein the plurality of electrodes is a first plurality of electrodes and further comprising a second plurality of electrodes, and wherein the first plurality of electrodes is supported to contact a user's face by a first sensor arm and the second plurality of electrodes is supported to contact a user's face by a second sensor arm.

11. The wearable device of claim 1, further comprising a control module configured to change a mode of the wearable device, in response to an activation signal recognized by the processing module from electrical signals recorded by the plurality of electrodes.

12. The wearable device of claim 11, further comprising one or more input sensors configured to provide signals to the control module.

13. The wearable device of claim 1, further comprising one or more sensors configured to detect a position of a tongue of the user and transmit to the processing module a signal indicative of the position of the tongue.

14. The wearable device of claim 1, further comprising a plurality of microphones, wherein the processing module is configured to receive signals from the plurality of microphones and perform beamforming on the signals received from the plurality of microphones.

15. The wearable device of claim 1, further comprising a camera.

16. The wearable device of claim 1, further comprising an accelerometer configured to record movement of a jaw, a cheek, facial muscles, the head or the neck of the user.

17. A system, comprising the wearable device of claim 1, wherein the communication module is communicatively coupled to an external device; and
the external device, wherein the external device is configured to receive one or more silent or whispered speech signals from the communication module and the external device is configured to determine one or more phrases silently spoke by the user from the silent or whispered speech signals by executing a neural network on the silent or whispered speech signals.

18. The system of claim 17, wherein the external device comprises a display configured to display a user interface, and wherein the external device is configured to perform natural language processing to determine one or more commands from the one or more words or phrases and control the user interface based on the one or more commands.

19. The system of claim 18, wherein the external device is configured to provide a virtual assistant platform and wherein the external device is configured to provide the one or more words or phrases as inputs to the virtual assistant platform.

20. The system of claim 19, further comprising a speaker, wherein the external device is configured to transmit a response to the one or more words or phrases from the virtual assistant platform to the wearable device, and the wearable device is configured to play the response on the speaker, in response to receiving the response.
